(19) United States
(12) Patent Application Publication
(10) Pub. No.: US 2023/0336015 A1
(43) Pub. Date: Oct. 19, 2023

(54) CIRCUIT-SWITCHABLE ELECTROCHEMICAL NETWORK

(71) Applicant: Walter A. Tormasi, Martinsville, NJ (US)

(72) Inventor: Walter A. Tormasi, Martinsville, NJ (US)

(21) Appl. No.: 17/803,995

(22) Filed: Feb. 24, 2023

Related U.S. Application Data
(60) Provisional application No. 63/473,288, filed on May 17, 2022.
(60) Provisional application No. 63/372,914, filed on Apr. 15, 2022.

(51) Int. Cl. H02J 7/00; H01M 10/04; H01M 50/202; H01M 50/204

(52) U.S. Cl. CPC H02J 7/007; H01M 10/0445; H02J 7/0013; H02J 7/0047; H01M 50/202; H01M 50/204

(57) ABSTRACT

A battery system comprises multiple electrochemical units for receiving, storing, and providing electricity; an integrated network of specially arranged conductors for carrying and transmitting electricity from, to, among, and/or between the electrochemical units; and various strategically interspersed current-regulating devices for predeterminatively routing electricity through the conductors. The electrochemical units may be in the form of cells, modules, packs, or other types of containers or enclosures. The conductors are arranged to enable two or more connection modes, said connection modes being selected from the group consisting of series, parallel, and series-parallel connections. The current-regulating devices are positioned in proximity to desired rerouting points and are capable of controlling the path of electricity through the network of conductors and thereby selectively and temporarily altering the connection mode of the electrochemical units.

### CROSS-REFERENCE TO RELATED APPLICATIONS

Priority is hereby claimed to U.S. Provisional Patent Application Nos. 63/372,914 and 63/473,288, said applications filed in April 2022 and May 2022, respectively.

### FIELD OF THE INVENTION

The present disclosure relates generally to rechargeable electrochemical cells and, more particularly, to means for allowing battery systems to reconfigure their electrical connections for charging and discharging purposes.

### BACKGROUND OF THE INVENTION

Batteries are important in modern society. Many electronic devices depend on batteries to function. Such battery-dependent devices include cellular phones, electric vehicles, and portable computers. There are billions of battery-dependent devices in existence, making batteries not only ubiquitous but also important for maintaining social contact, productivity, public safety, and the like.

All batteries contain one or more electrochemical cells. A battery cell features three primary components. Those components comprise an anode (negative electrode), cathode (positive electrode), and electrolyte (ion-transportation medium). Other cell components include opposing current collectors and an intermediate separator membrane.

For reference purposes, FIG. 1 (Prior Art) depicts the above-described cell construction. The cell, anode, cathode, electrolyte, collectors, and separator are represented as elements 1, 2, 3, 4, 5, and 6, respectively.

Most battery cells for mobile devices are rechargeable. Rechargeable cells fall into various chemical classes. Those chemical classes include nickel-cadmium (Ni—Cd), nickel-metal hydride (Ni-MH), and lithium-ion (Li-ion). Each class has particular advantages and disadvantages relating to energy density, cost, cycle life, and other criteria.

All rechargeable cells must be charged from an external power source. In most cases, external power is supplied by the electrical grid. It is possible, however, to charge cells via photovoltaic panels, engine-driven alternators, and other electricity-generating devices. Regardless of which external power source is utilized, alternating current must be converted to direct current for cell-charging purposes.

The charging process, in general, is fairly straightforward. During the charging process, electrons travel from the external power source to the anode. The electrons entering the anode cause atoms (e.g., lithium ions) to travel from the cathode to the anode. That reaction creates electrical potential (voltage variance) between the electrodes.

To draw energy from charged cells, an external load, such as an electric motor or appliance, is connected to the cell terminals. The electrochemical process now occurs in reverse of the order discussed above. That is, when the cell is subjected to an external load, electrons travel from the anode to the current-drawing device. Atoms (e.g., lithium ions) thereupon migrate from the anode to the cathode.

FIG. 2 (Prior Art) and FIG. 3 (Prior Art) illustrate the foregoing charging and discharging processes, respectively. The aforementioned current collectors and separator membrane have been omitted from the drawings for simplicity. Because lithium-ion batteries dominate the marketplace, both drawings are tailored to lithium-based chemistry. Thus, in both figures, lithium ions (labeled Li⁺) are shown traveling between the anode and cathode, with electrons (labeled el entering or exiting the cell terminals.

Although FIG. 2 (Prior Art) and FIG. 3 (Prior Art) relate to lithium-ion cells, all rechargeable cells rely on electrochemical reactions. Those reactions create electrical potential and allow energy to be stored and released. In that respect, it can be said, for present purposes, that all rechargeable cells are identical in form and function.

Regardless of their chemistries or operating principles, battery cells must be contained and packaged for end use. Individual cells are typically housed in cylindrical, prismatic, or pouched containers. Whatever type of container is employed, multiple containers are typically integrated into modules or packs. Some modules/packs, such as those designed for use in electric vehicles, contain thousands of cells.

All electrochemical cells are limited by their chemical compositions. Different cell classes therefore have different voltage and capacity ratings. Nickel-cadmium and nickel-metal hydride cells, for example, are nominally rated at around 1.2 volts. In contrast, lithium-ion cells feature nominal voltage ratings between 3.2 and 3.85 volts, depending on the specific chemicals employed in the cathode and other components. Variances also exist regarding cell capacity (measured in ampere-hours), with lithium-ion cells having greater volumetric and gravimetric energy density in relation to nickel-cadmium and nickel-metal hydride cells.

The foregoing voltage and capacity limitations can be overcome by connecting multiple electrochemical cells in series, in parallel, or in hybrid series-and-parallel configuration. Such electrical arrangements are depicted, respectively, in FIG. 4 (Prior Art), FIG. 5 (Prior Art), and FIG. 6 (Prior Art). Those prior-art drawings are in schematic format and employ industry-standard symbols and marks to represent the cells, interconnections, and terminals.

The benefits of series, parallel, and hybrid configurations are governed by mathematical formulas and principles, including Ohm's Law. A series connection, of course, increases overall voltage in proportion to the number of cells, but current/amperage remains unchanged. A parallel connection achieves opposite results. That is, overall current increases in proportion to the number of cells, but voltage remains unchanged. A hybrid arrangement, consisting of interconnected strings and banks of series and parallel cells, combines the respective benefits of both configurations.

Some battery modules/packs, as noted, contain thousands of cells. Regardless of the number of cells employed in multi-cell systems, the specific electrical arrangement of those cells is tailored to satisfy usage-related requirements or preferences. So battery systems designed for high-voltage or high-amperage applications will feature multiple cells connected in series or parallel, respectively. It is quite common, however, for multi-cell systems to employ both types of connections, thereby achieving combined electrical benefits.

The assembly of battery modules and packs involves two basic steps. The cells are first placed in compartments located within the module/pack. The purpose of the compartments is to seat the cells and to perform heat-dissipation and other functions. The cells are then permanently or semi-permanently wired in series, parallel, or hybrid mode. The wires are typically connected through strips, plugs, or other fastening mechanisms. Although large-scale battery packs (such as those for vehicular use) may employ multiple modules, the assembly processes for modules and packs are similar, at least in relation to the containment and wiring of individual cells.

Conventional electrochemical cells, modules, and packs feature fixed voltage and amperage ratings. This is because the number of electrochemical units, as well as their interconnections, is static. The battery system, in other words, cannot be dynamically altered. Once cells are placed in modules/packs, and once such units are wired in series, parallel, or hybrid mode, mathematical and other principles dictate their systemic electrical characteristics. Conventional battery systems, accordingly, are limited to specific voltages and amperages for charging and discharging purposes.

The design of battery modules and packs involves competing considerations. One consideration relates to energy capacity, which impacts overall battery life during consumptive end use. Another consideration relates to current flow, which impacts the safety and speediness of recharging. Both considerations are greatly influenced by voltage levels.

Many electric-vehicle companies employ battery systems nominally rated at around 350 volts (i.e., 400 volts maximum). That voltage level necessitates the employment of 96 series-connected cells (assuming that each cell is nominally rated at 3.6 volts). Numerous 96-cell strings are then arranged in parallel. The parallel-connected cells increase energy capacity (ampere-hours) without changing the 350-volt electrical potential created by each 96-cell series string. In that regard, 350-volt systems allow electric vehicles to maintain reasonable battery life and meet consumer expectations.

Higher-voltage systems, however, are beneficial for charging purposes. Here, again, cell arrangement comes into play. To create higher-voltage systems, more cells must be connected in series, meaning that fewer parallel-connected cells are employed. Using fewer parallel-connected cells, of course, results in lower current/amperage throughout the battery network. The charging process therefore generates less heat, allowing safer charging. The reduced heat levels, however, can be offset by increasing charging current and thereby reducing charging time. Higher-voltage batteries, in short, provide numerous benefits during the recharging process.

Given these competing interests, it is advantageous for battery systems to adopt lower-voltage configurations for end-use purposes and higher-voltage configurations for recharging purposes. Conventional battery systems, however, are incapable of altering their electrical connections, preventing such systems from employing varying voltage rates.

Another limitation with conventional systems concerns discharge-related voltage drops. Electrochemical cells, modules, and packs experience progressive voltage drops when undergoing depletion. A battery system maximally rated at 400 volts, for example, could have its electrical potential reduced by 20% to 35%, to around 290 volts, once its low-energy state is reached. The percentage of the voltage drop, as well as the uniformity of the voltage-indexed discharge curve, varies among different battery classes. All battery classes, however, experience progressive voltage drops while discharging.

It would be advantageous for battery systems to eliminate or mitigate discharge-related voltage drops. This is because voltage drops during the discharge phase will significantly alter the electrical characteristics of the battery system, resulting in inconsistent or unstable/unreliable output. Unfortunately, due to their static nature (that is, given their inability to dynamically alter their connection modes), conventional battery systems remain susceptible to, and disadvantaged by, discharge-related voltage drops.

Various reconfigurable battery systems (RBSs) have been proposed or implemented. All RBSs are capable of dynamically altering their electrical connections, doing so by employing an array of switching devices. Prior-art RBSs, however, are either insufficiently capable or overly complex.

For present purposes, prior-art RBSs can be distinguished based on two metrics. One metric relates to the level of reconfigurability, while the other metric relates to the number of switching devices per electrochemical unit.

Regarding the reconfigurability metric, some RBSs are merely capable of performing cell-bypass functions. Such functions, although useful for isolating defective cells, cannot overcome the limitations discussed above. Other RBSs are more capable, allowing their electrochemical units to switch among series, parallel, and/or series-parallel connections.

Regarding the relativistic metric, RBSs are distinguishable based on their switch-to-cell ratios. One multi-mode RBS, for example, employs three switches per electrochemical cell, meaning that the ratio of switches to cells is 3:1. Other multi-mode RBSs have higher switch-to-cell ratios, with some RBSs featuring six switches per cell.

RBSs with high switch-to-cell ratios are disfavored. This is because employing more switches per cell not only increases manufacturing costs but also results in greater heat production. These disadvantages are especially problematic for battery systems containing thousands of cells.

At present, no multi-mode RBS has fewer than three switches per cell. (Other RBSs feature switch-to-cell ratios lower than 3:1, but those RBSs are limited to cell-bypass functions and, as such, cannot switch among series, parallel, and/or series-parallel connections.) Thus, any multi-mode RBS employing fewer than three switches per cell would be structurally distinguishable from prior-art systems.

### SUMMARY OF THE INVENTION

Disclosed is an integrated system of electrochemical units, specially arranged conductors, and strategically interspersed current-regulating devices. Those components, as structured, allow battery systems to alter their electrical potential (among other characteristics) by controlling whether their electrochemical cells, modules, or packs are connected in series mode, parallel mode, or hybrid series-parallel mode. Through such connection-mode adjustments, battery systems can dynamically switch among lower-voltage, intermediate-voltage, and higher-voltage configurations, thereby overcoming major limitations in prior-art devices.

The invention, as noted, encompasses three primary battery-related components. Additional components, however, can be incorporated into the disclosed battery system.

First and foremost, the invention comprises multiple electrochemical units for receiving, storing, and providing electricity. The electrochemical units may be in the form of cells, modules, packs, or combinations thereof. The electrochemical units, moreover, may be composed of any recharge-capable chemical composition (including nickel-cadmium, nickel-metal hydride, and lithium-ion) and may be constructed from any material in any shape, size, and format.

The invention also comprises an arrangement of conductors for carrying and transmitting electricity. The conductors are arranged to allow the electrochemical units to operate in two or more connection modes. The connection modes may be chosen from any preferred combination of series, parallel, and series-parallel configurations. Because the number of potential circuit layouts is limitless, any number of connection-mode combinations can be adopted and employed.

The disclosed battery system also comprises multiple current-regulating devices. The current-regulating devices are intended to control the path of electricity through the network of conductors and thereby control whether the electrochemical units are connected in series mode, parallel mode, or series-parallel mode. Any component capable of regulating current can be used to implement the foregoing function. Suitable regulating/routing devices include not only mechanical switches but also electronic switches such as transistors, semiconductor-controlled rectifiers, and relays.

The above components, as structured, allow battery systems to selectively and temporarily reconfigure their electrical connections. Because changes in connection mode will impact the overall electrical potential and other characteristics of the battery system, the invention affords various advantages during the charging and/or discharging processes. The specific advantages will depend on how artisans and manufacturers choose to practice particular embodiments of the disclosed circuit-switchable battery system.

Practitioners, for example, may employ the invention to provide battery systems with one lower-voltage setting during the discharge phase and one higher-voltage setting during the recharge phase. That implementation method could enable longer battery life during consumptive end use, while also allowing for safer and/or faster charging.

Practitioners may also employ the invention to provide battery systems with various stepped-voltage or intermediate-voltage settings. Practitioners can then configure the battery system to periodically increase its voltage rating during the discharge phase. That implementation method could eliminate or mitigate discharge-related voltage drops.

### BRIEF DESCRIPTION OF THE DRAWINGS

Fifty-seven drawings are supplied. Of those drawings, six depict prior art and are provided for reference purposes. The remaining drawings inclusively illustrate miscellaneous aspects, embodiments, or features of the disclosed battery system. Such drawings are intended to complement the disclosure without limiting the scope of the invention, which is defined exclusively by the claims appended hereto.

FIG. 1 (Prior Art), FIG. 2 (Prior Art), and FIG. 3 (Prior Art) depict, in cross-sectional view, an electrochemical cell while idling, charging, and discharging, respectively.

FIG. 4 (Prior Art), FIG. 5 (Prior Art), and FIG. 6 (Prior Art) depict, in schematic format, an ordinary circuit comprising multiple electrochemical cells connected in series mode, parallel mode, and series-parallel mode, respectively.

FIG. 7, FIG. 8, and FIG. 9 depict, in schematic format, various customized circuits featuring specially arranged supplemental conductors in accordance with the invention.

FIG. 10, FIG. 11, FIG. 12, and FIG. 13 depict, in schematic format, embodiments of the invention, said embodiments employing either electrochemical cells (as in FIGS. 10 and 12) or electrochemical modules/packs (as in FIGS. 11 and 13).

FIG. 14, FIG. 15, FIG. 16, and FIG. 17 depict, in schematic format, the flow/path of current during charging and discharging for the embodiments depicted in FIGS. 10 through 13.

FIG. 18, FIG. 19, FIG. 20, and FIG. 21 depict, in schematic format, embodiments of the invention, said embodiments employing either electrochemical cells (as in FIGS. 18 and 20) or electrochemical modules/packs (as in FIGS. 19 and 21).

FIG. 22, FIG. 23, FIG. 24, and FIG. 25 depict, in schematic format, the flow/path of current during charging and discharging for the embodiments depicted in FIGS. 18 through 21.

FIG. 26, FIG. 27, FIG. 28, FIG. 29, FIG. 30, FIG. 31, FIG. 32, and FIG. 33 depict, in schematic format, embodiments of the invention, said embodiments employing either electrochemical cells (as in FIGS. 26, 28, 30, and 32) or electrochemical modules/packs (as in FIGS. 27, 29, 31, and 33).

FIG. 34, FIG. 35, FIG. 36, FIG. 37, FIG. 38, FIG. 39, FIG. 40, and FIG. 41 depict, in schematic format, the flow/path of current during charging and discharging for the embodiments depicted in FIGS. 26 through 33.

FIG. 42 and FIG. 43 depict, in schematic format, embodiments of the invention, said embodiments employing multiple interconnected electrochemical modules/packs.

FIG. 44, FIG. 45, FIG. 46, and FIG. 47 depict, in schematic format, the flow/path of current during charging and discharging for the embodiments depicted in FIGS. 42 through 43.

FIG. 48 and FIG. 49 depict, in schematic format, embodiments of the invention, said embodiments employing multiple interconnected electrochemical units rated at 50 volts.

FIG. 50, FIG. 51, FIG. 52, and FIG. 53 depict, in schematic format, the flow/path of current during charging and discharging for the embodiments depicted in FIGS. 48 through 49.

FIG. 54 depicts, in schematic format, embodiments of the invention, said embodiments employing multiple interconnected electrochemical units capable of intra-modularly alternating between 25-volt and 50-volt connection modes.

FIG. 55 depicts, in schematic format, embodiments of the invention, said embodiments employing multiple interconnected electrochemical units capable of intra-modularly alternating between 50-volt and 100-volt connection modes.

FIG. 56 and FIG. 57 depict, in flowchart format, various operational processes capable of being implemented in accordance with one or more embodiments of the invention.

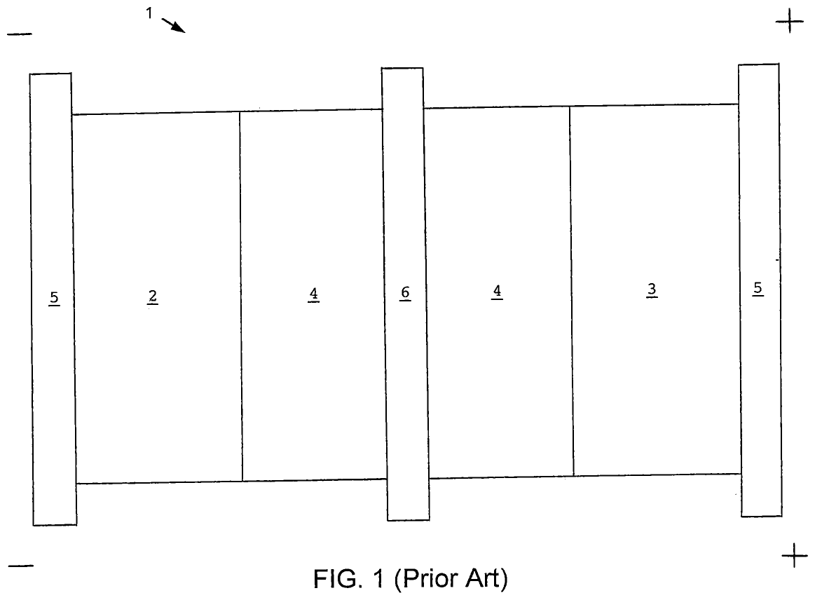

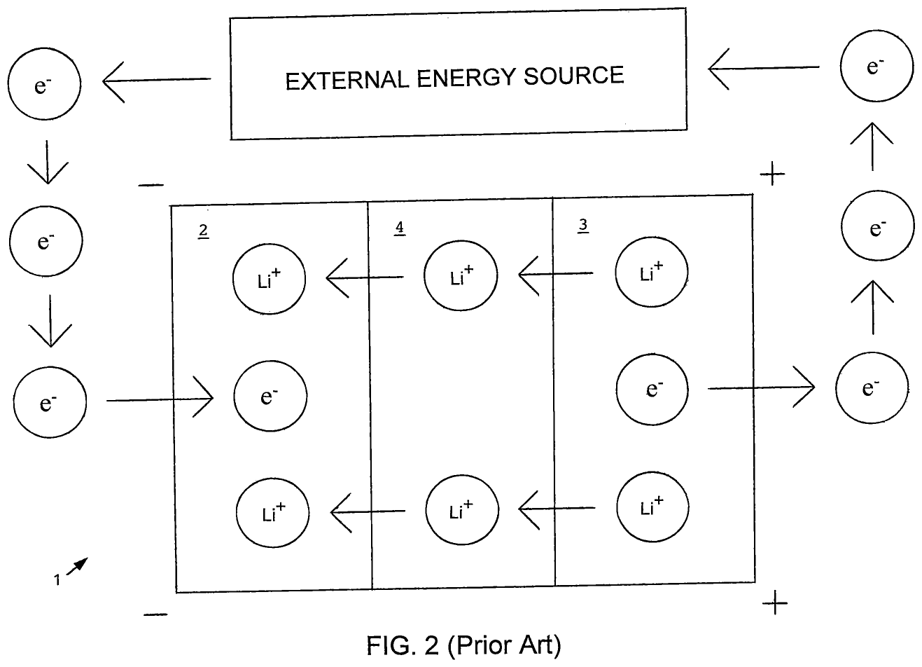

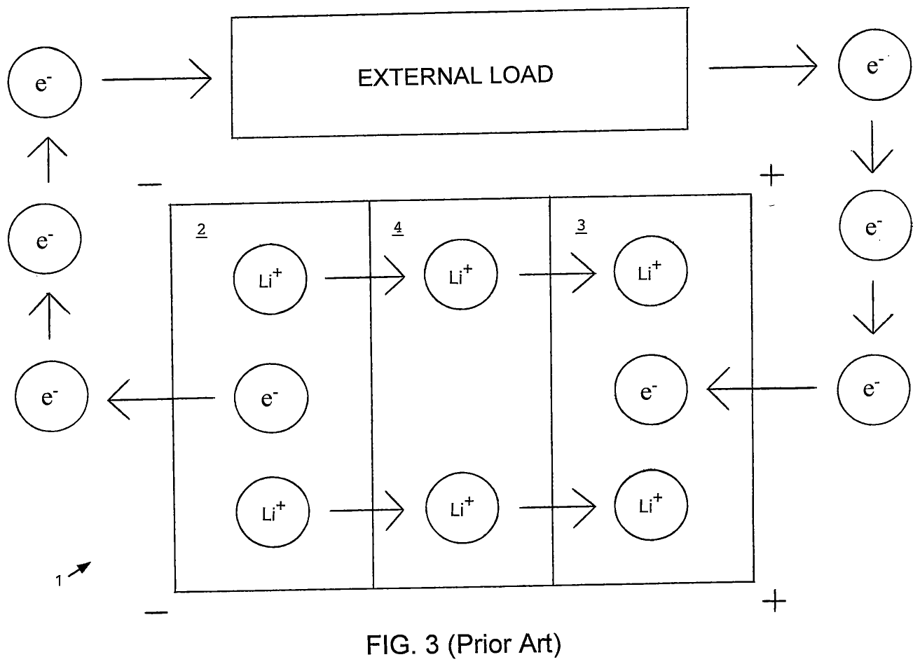

The foregoing drawings, as well as the elemental components illustrated therein, are thoroughly and comprehensively discussed in the below disclosure.

### DETAILED DESCRIPTION OF THE INVENTION

The invention, as indicated, comprises three main components, namely, multiple electrochemical units for receiving, storing, and providing electricity; an integrated network of specially arranged conductors for carrying and transmitting electricity; and strategically interspersed current-regulating devices for controlling the path of electricity through the network of conductors and thereby controlling whether the electrochemical units are connected in series mode, parallel mode, or series-parallel mode. The above components are discussed below. Also discussed below are various embodiments and advantages of the invention.

There are, of course, many types of electrochemical units capable of being employed within the battery system as invented. The electrochemical units may be in the form of cells, modules, packs, or other vessels. Such units, including combinations of different unit types, can be utilized for the purpose of receiving, storing, and providing electricity.

The electrochemical units may be constructed of any suitable materials. Standard materials include aluminum, stainless steel, and plastic, but other materials, such as rubber, carbon fiber, and ceramic, are feasible.

The electrochemical units can be in any shape, size, geometry, or dimension. The units, accordingly, may take the form of cylindrical, prismatic, pouched, or coinlike containers. Such styles are popular for single-cell containers but can be employed in connection with multi-cell modules or packs. The specific shape, size, geometry, and dimension of the electrochemical units will necessarily depend on end-use considerations. Large battery systems, for example, will require voluminous enclosures with custom contours, while small battery systems may rely on off-the-shelf vessels.

As alluded to above, it is intended that the electrochemical units be rechargeable. Rechargeable units, also known as secondary batteries, are available in various chemical compositions. Common compositions include nickel-cadmium, nickel-metal hydride, and lithium-ion (with the latter composition presently dominating the marketplace). Those and other types of electrochemical units, including existing or emerging solid-electrolyte designs, can be employed.

The disclosed battery system, as noted, also encompasses an integrated network of specially arranged conductors. The conductors are responsible for carrying/transmitting electricity from, to, among, and/or between the electrochemical units. Any type of conducting element may be used to accomplish that function.

Suitable conductors include metallic wires and rails, but metallic circuit-board traces and other physical conduits are equally employable. The conductors, however, need not be solid in nature. This is especially the case regarding induction-based interfaces. Those interfaces typically use air as an intermediary. Although air is generally viewed as an insulator, air is fully capable of transmitting electricity via electromagnetic induction. Thus, for present purposes, gaseous media, including air, can serve as conducting elements.

Practitioners should be mindful of applicable resistance and current ratings in making their conductor selections. Conductor resistance, in general, should be as low as possible (meaning that thicker and shorter conductors are preferred) in order to minimize heat production. Moreover, because heat production is further influenced by overall current flow, the chosen conductor should meet or exceed the maximum amperage rating of the battery system in question.

In accordance with the invention, it is necessary that the conductors be attached to or in communication with the electrochemical units via two or more connection modes. The multitude of available connection modes is intended to permit alternative paths of current flow. The connection modes may be selected from any preferred combination of series, parallel, and series-parallel configurations. Any specific multitude and combination of connection modes are employable, giving practitioners substantial implementation leeway.

The conductors, in that regard, can be affixed to or in communication with the electrochemical units in countless configurations. Under one embodiment, the conductors may form coexisting series and parallel connections. Under another embodiment, the conductors may form coexisting series and series-parallel connections or, equally possible, coexisting parallel and series-parallel connections. Under an additional embodiment, the conductors may form coexisting series-parallel and series-parallel connections. Other connection-mode combinations can also be employed pursuant to the invention.

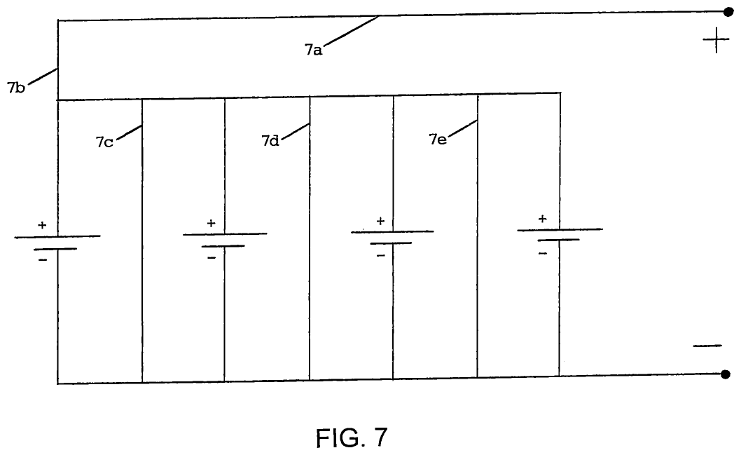

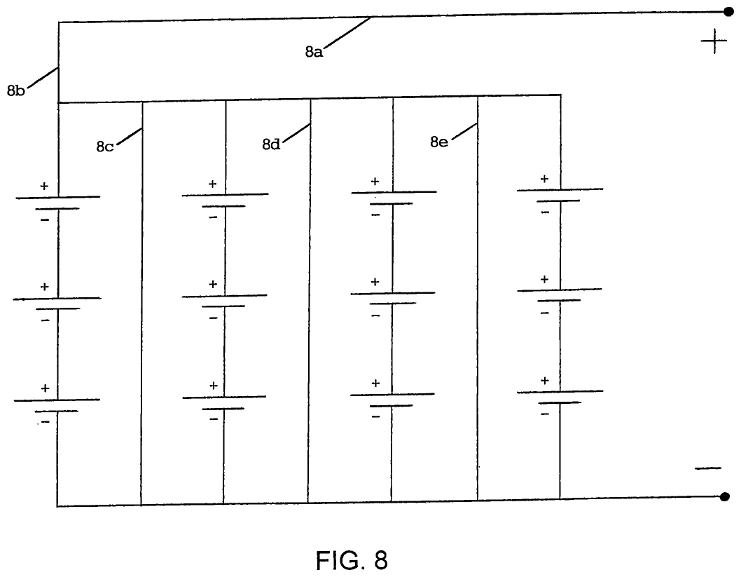

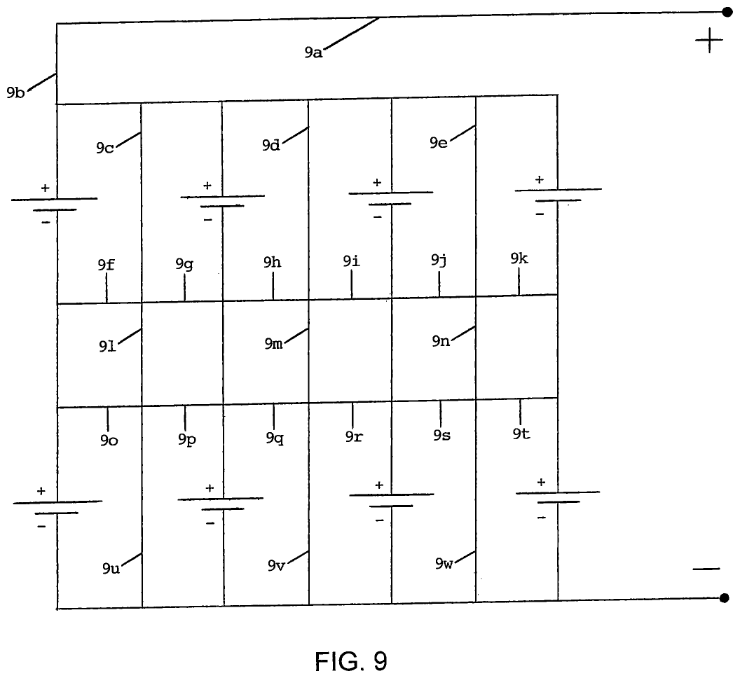

FIG. 7, FIG. 8, and FIG. 9 depict, in schematic format, various conductor arrangements as invented. Shown therein are supplemental conductors 7a through 7e (depicted in FIG. 7); supplemental conductors 8a through 8e (depicted in FIG. 8); and supplemental conductors 9a through 9w (depicted in FIG. 9). Of those elements, supplemental conductors 7a and 7b (in FIGS. 7), 8a and 8b (in FIGS. 8), and 9a and 9b (in FIG. 9) serve as newly created positive rails, while the remaining supplemental conductors serve as newly created mode-enabling pathways and/or newly created mode-enabling intersections.

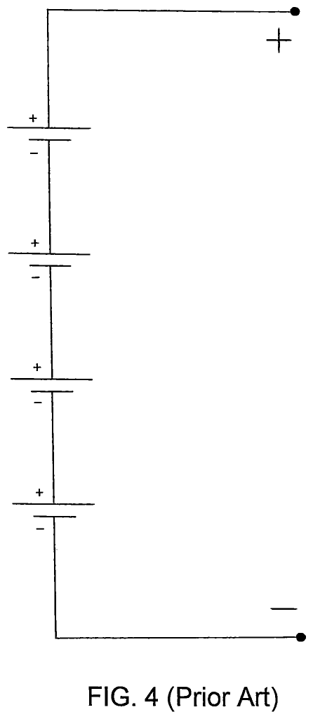

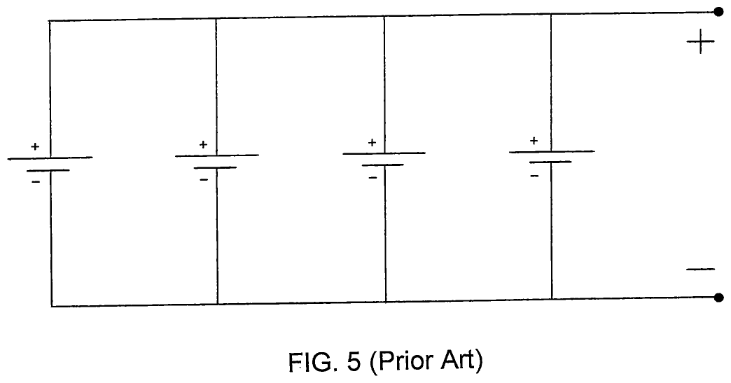

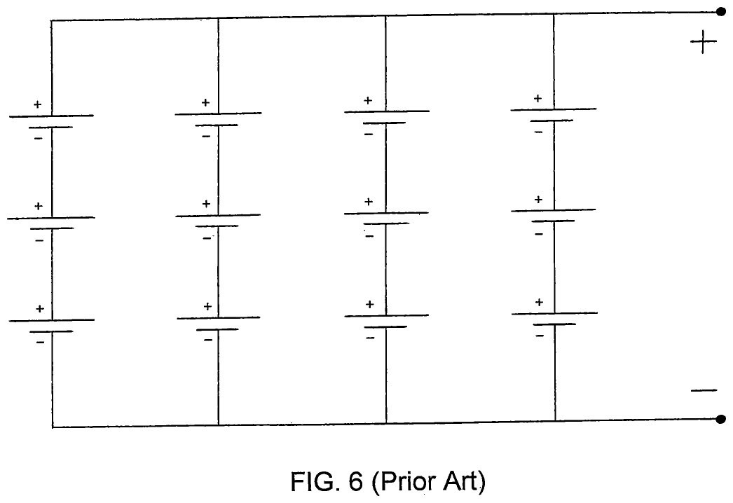

It should be noted that the foregoing conductor embodiments differ from FIG. 4 (Prior Art), FIG. 5 (Prior Art), and FIG. 6 (Prior Art). One critical difference relates to the sheer number of conductors employed in the circuit. Another critical difference relates to the unique structural relationship of the conductors. Specifically, regarding the former difference, the number of conductors in FIGS. 7 through 9 greatly exceeds the number of conductors used in prior-art systems. And regarding the latter difference, all supplemental conductors in FIGS. 7 through 9 are specially structured to enable coexisting connection-mode combinations.

It is acknowledged that most of the supplemental conductors shown in FIGS. 7 through 9 would be regarded as pointless, unnecessary, or counterproductive under normal circumstances. In other words, electronic circuits would not normally be designed or constructed in the manner depicted in FIGS. 7 through 9. This is especially the case given the universal view that the complexity of circuits should be no greater than required to perform the intended function.

Needless to say, the unique conductor arrangements shown in FIGS. 7 through 9 are considered unorthodox or antithetical under normal circumstances. The circumstances here, however, are anything but normal, for this disclosure is directed at providing battery systems with the ability to reconfigure their electrical connections for charging and discharging purposes. Absent intent or motivation by skilled artisans to implement that function, the unique conductor arrangements shown in FIGS. 7 through 9 would never have been suggested or adopted by others, which is the situation here. So the disclosed conductor arrangements constitute an innovative aspect of the circuit-switchable battery system at issue.

Now, turning to the third and final enabling component of the invention, the path of electricity through the network of conductors must be controllable. The control capabilities are accomplished by using strategically interspersed current-regulating devices. The current-regulating devices, as arranged, are intended to allow battery systems to control whether their electrochemical units are connected in series mode, parallel mode, or series-parallel mode.

Any type of current-regulating device can be used in the disclosed battery system. The current-regulating devices, as such, may be mechanical, electronic, or electromechanical in nature. Falling in the mechanical class are toggle switches and circuit breakers/interlocks. Falling in the electronic class are transistors, semiconductor-controlled rectifiers, and relays. Some of the above current-regulating devices feature electromechanical characteristics and are capable of being collectively mixed or matched.

The current-regulating devices may constitute one or more components of an auxiliary, master, or supervisory battery-management system (BMS). Most sophisticated electrochemical modules and packs feature an appliance for monitoring and controlling battery-related functions during the charging and discharging processes. Such an appliance or system, including components thereof (e.g., interfacing wires or connectors), may serve as the current-regulating device(s).

Each type of current-regulating device, as well as particular combinations thereof, will have unique advantages and disadvantages. The advantages and disadvantages relate to complexity, cost, performance, and other metrics. All such considerations should be weighed by the practitioner or manufacturer in choosing which devices to employ.

With the current-regulating devices having been selected, the placement thereof is now ripe for discussion. The current-regulating devices, as noted, must be strategically interspersed within the network of conductors. The exact positioning of the current-regulating devices will depend on the exact circuit layout adopted. It can generally be stated, however, that the current-regulating devices are positioned in proximity to desired rerouting intersections or paths.

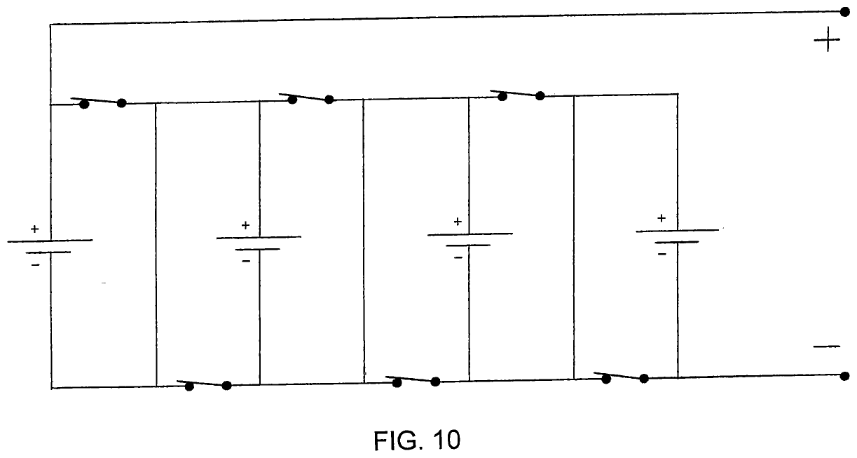

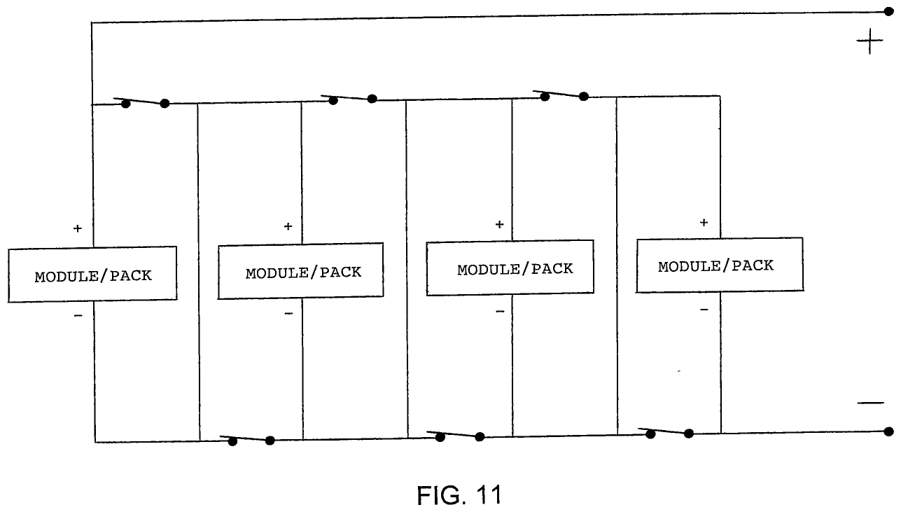

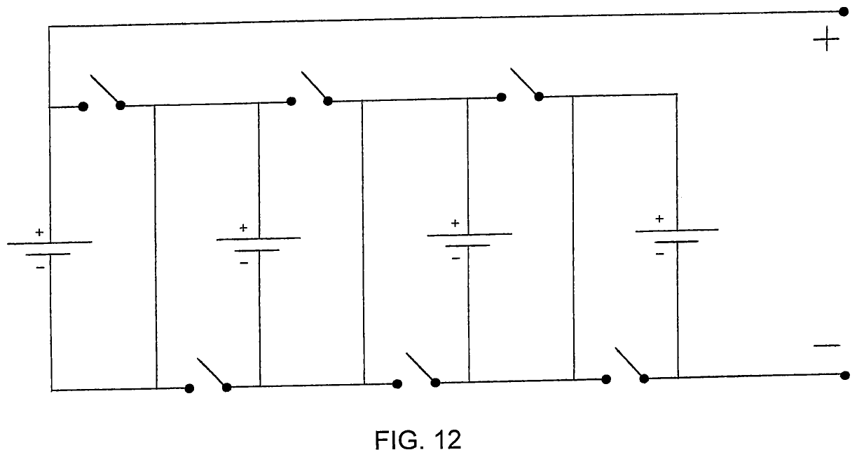

FIGS. 10 through 53 depict, in schematic format, various electrochemical networks featuring strategically interspersed current-regulating devices. All drawings employ industry-standard symbols, labels, and marks to represent components, interconnections, conductors, and terminals.

The current-regulating devices shown in FIGS. 10 through 53 are schematically represented using symbols for mechanical switches. Such symbols are employed solely for purposes of simplicity and comprehensibility. As indicated, any type of current-regulating device may be used, regardless of whether the device is mechanical, electronic, or electromechanical in nature. The mechanical switches shown in FIGS. 10 through 53, accordingly, are intended to exemplify, rather than limit, the battery system as invented.

With that stipulation, focus will now be placed on the embodiments depicted in the aforementioned drawings. A detailed description of FIGS. 10 through 53, as well as the remaining drawings, is therefore provided. Also provided are additional enabling comments, including suggestions, advisements, and methods for implementing and practicing one or more embodiments of the disclosed battery system.

The embodiment depicted in FIGS. 10 through 13 features four electrochemical units, three vertically oriented supplemental conductors, and six switches. The electrochemical units are in the form of either cells (as shown in FIGS. 10 and 12) or modules/packs (as shown in FIGS. 11 and 13). The supplemental conductors and switches are specially arranged and strategically interspersed, respectively, in order to provide the battery system with two discrete connection modes.

Specifically, referring to the aforementioned drawings, when all switches are closed (as shown in FIGS. 10 and 11), then all electrochemical cells, modules, or packs will be connected in parallel mode. In contrast, when all switches are opened (as shown in FIGS. 12 and 13), then all electrochemical cells, modules, or packs will be connected in series mode.

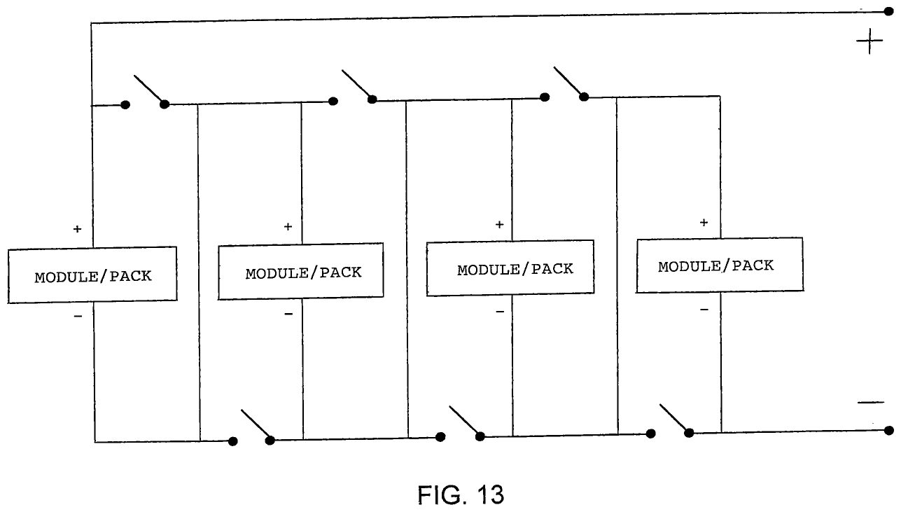

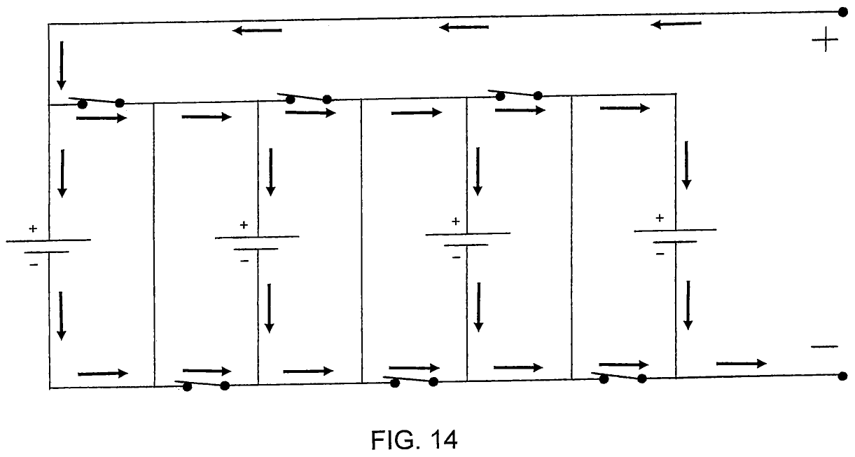

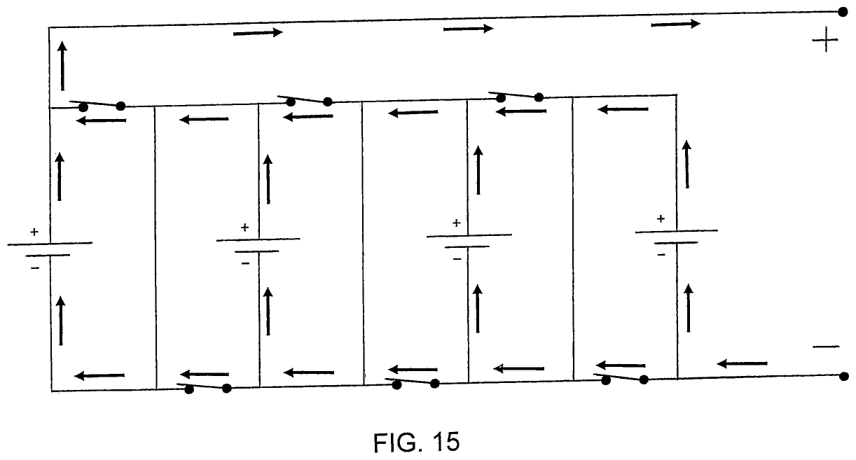

FIGS. 14 through 17 illustrate the path and direction of current flow within the foregoing electrochemical network during the charging and discharging processes. In those drawings (as well as in all other current-flow diagrams discussed below, namely, FIGS. 14 through 17, FIGS. 22 through 25, FIGS. 34 through 41, FIGS. 44 through 47, and FIGS. 50 through 53), the path and direction of current flow are denoted by arrows running along the conductors. Additionally, in accordance with scientific convention, all current-flow diagrams represent the flow of positive charge. Negative charge (i.e., electrons) would necessarily flow countervailingly.

Regarding FIGS. 14 through 17 and all other current-flow diagrams, it is worth noting that the flow of current will occur only when the circuit is connected to an energy source (during charging) or an electrical load (during discharging). Such instigating components are omitted from the current-flow diagrams to promote simplicity. All current-flow diagrams, however, are depicted under the assumption that the requisite charging and discharging devices are present.

As can be seen, FIGS. 14 and 15 illustrate current flow during charging and discharging, respectively, when all switches are closed. FIGS. 16 and 17 illustrate current flow during charging and discharging, respectively, when all switches are opened. Such current-flow diagrams employ cells as electrochemical units. The path and direction of current flow, however, will match the respective circuit layouts if electrochemical modules or packs are substituted for cells.

Regardless of the type of electrochemical units employed, the aforementioned current-flow diagrams highlight the circuit-switchable feature of the invention. The flow of current, in particular, indicates that electricity is capable of following alternative paths throughout the network. And by comparing and contrasting the current-flow paths, it becomes clear that the electrochemical units can be selectively and temporarily connected in parallel mode (when all switches are closed) or in series mode (when all switches are opened). These connection-mode changes are made possible by using specially arranged supplemental conductors and strategically interspersed current-regulating devices, as explained above.

Returning to FIGS. 10 through 13, it bears repeating that the embodiment therein features six switches and four electrochemical units. The ratio of switches to electrochemical units is therefore 1.5:1. Notably, because the switch-to-unit ratio is below 3:1, the foregoing embodiment is structurally distinguishable over prior-art systems.

Although the embodiment depicted in FIGS. 10 through 13 encompasses four electrochemical units, three vertically oriented supplemental conductors, and six switches, it should be understood that any multitude of units, conductors, and switches can be used. Also subject to variation are the location and positioning of the electrochemical units, supplemental conductors, and switches. The same flexibility applies to the chosen length of the series-connected string and the chosen width of the parallel-connected bank.

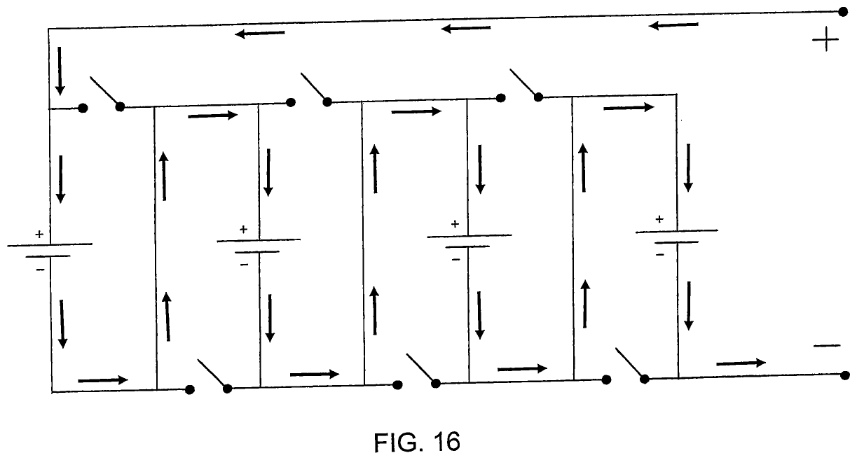

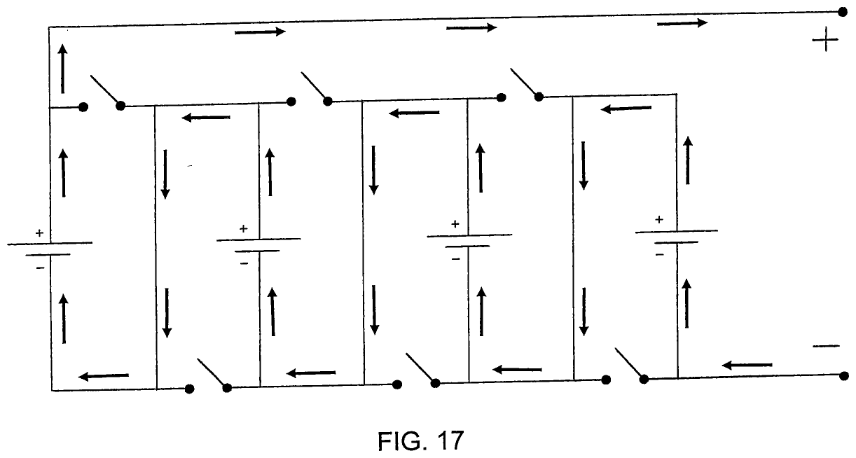

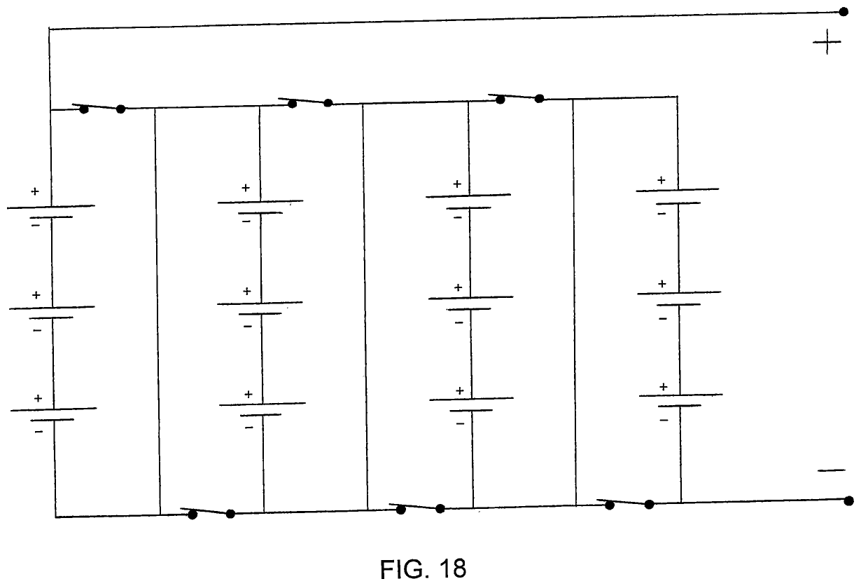

In that spirit, FIGS. 18 through 21 depict an alternative embodiment of the disclosed battery system. The embodiment therein features three times the number of electrochemical units than the prior embodiment. Similar to the prior embodiment, the electrochemical units are in the form of either cells (as shown in FIGS. 18 and 20) or modules/packs (as shown in FIGS. 19 and 21). But unlike the prior embodiment, the electrochemical units are connected in series-parallel mode, rather than parallel mode, when all switches are closed (as shown in FIGS. 18 and 19). The present and prior embodiments, however, feature similar series-mode capabilities. In particular, just like the prior embodiment, opening all switches (as shown in FIGS. 20 and 21) will activate series mode.

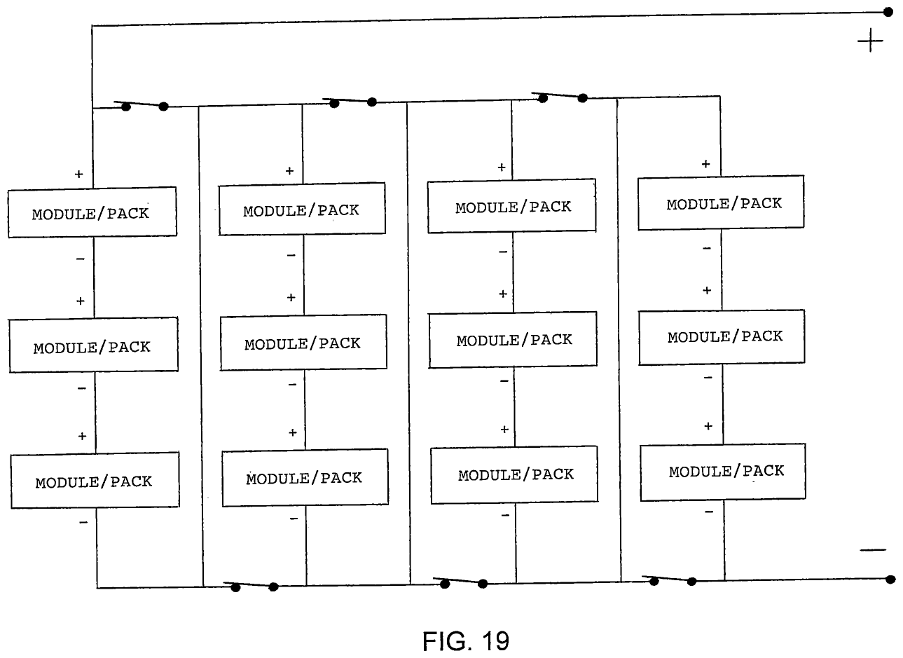

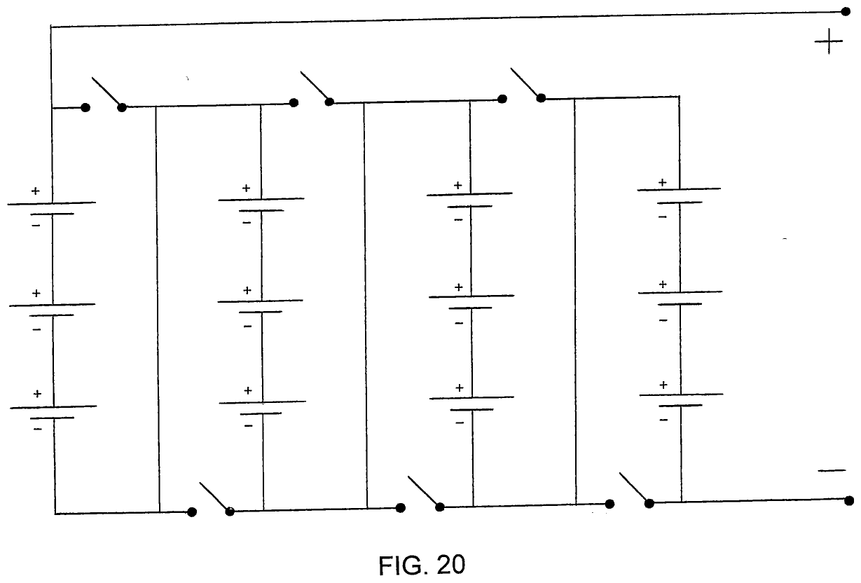

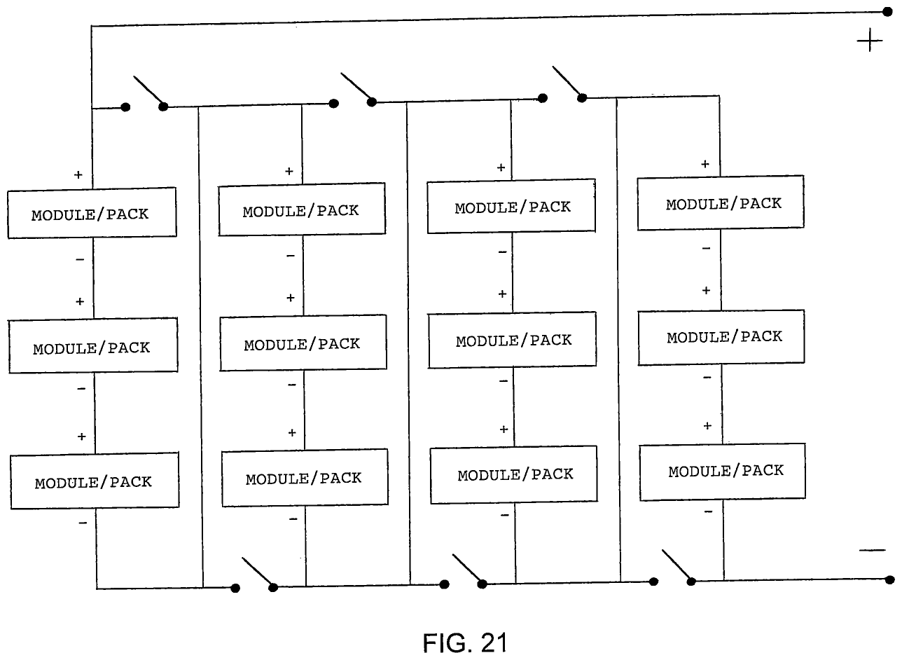

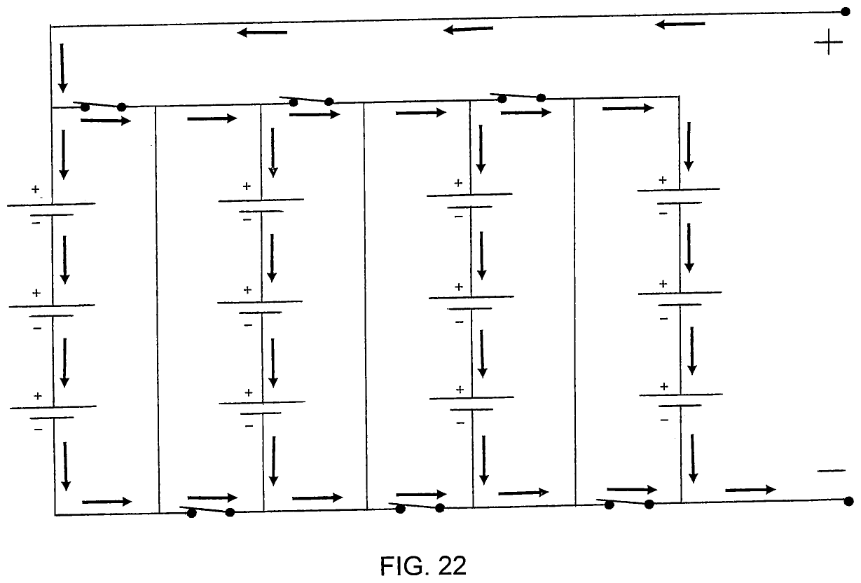

The foregoing connection-mode changes and capabilities are highlighted by FIGS. 22 through 25. Of those drawings, FIGS. 22 and 23 illustrate current flow during charging and discharging, respectively, when all switches are closed. The path of current flow, as indicated via arrows, confirms that the closed switches will configure the electrochemical units to operate in series-parallel mode. In contrast, FIGS. 24 and 25 illustrate current flow during charging and discharging, respectively, when all switches are opened. The path of current flow, as indicated via arrows, confirms that the opened switches will configure the electrochemical units to operate in series mode.

As seen, the embodiment illustrated in FIGS. 18 through 21 employs six switches and twelve electrochemical units. The switch-to-unit ratio is therefore 0.5:1. That ratio, being under 3:1, renders the foregoing embodiment structurally distinguishable from prior-art systems.

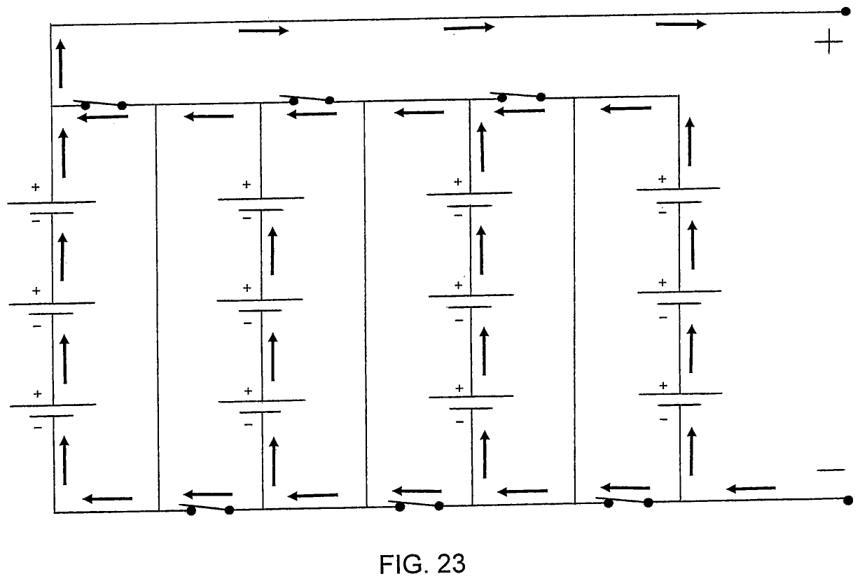

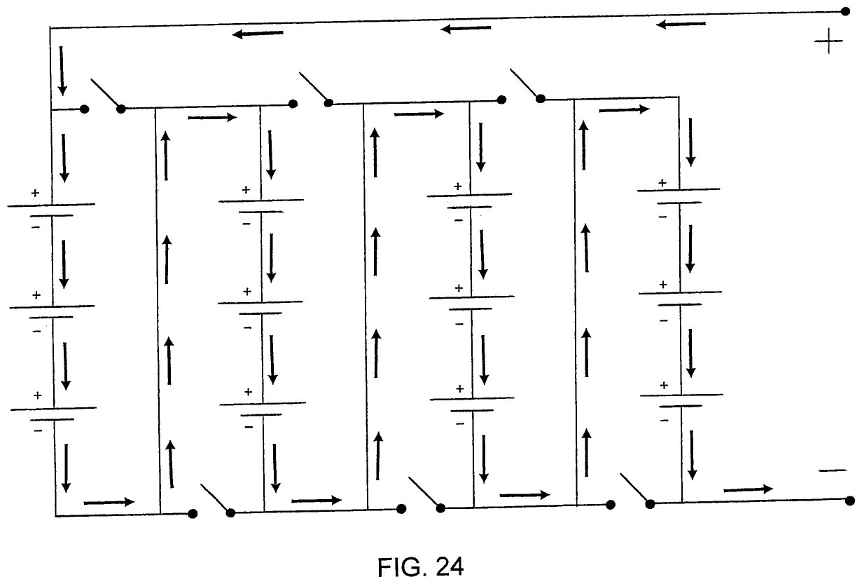

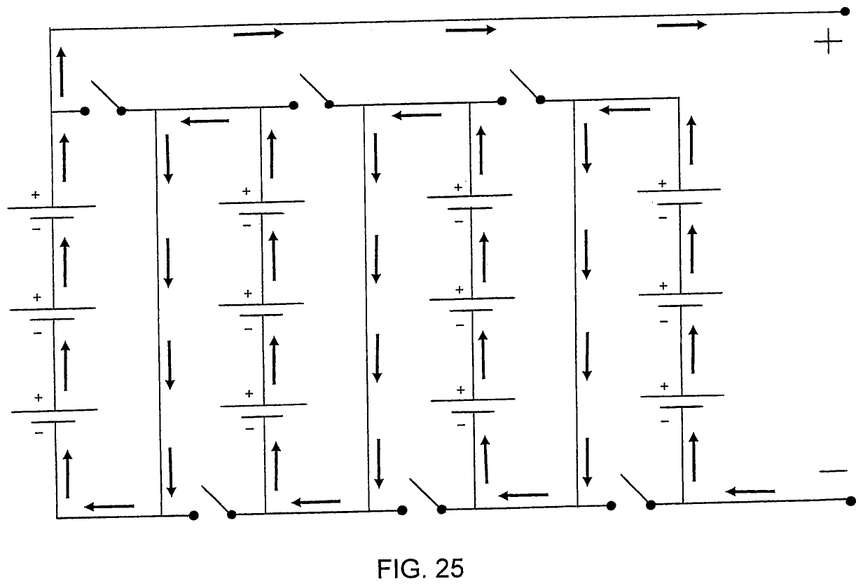

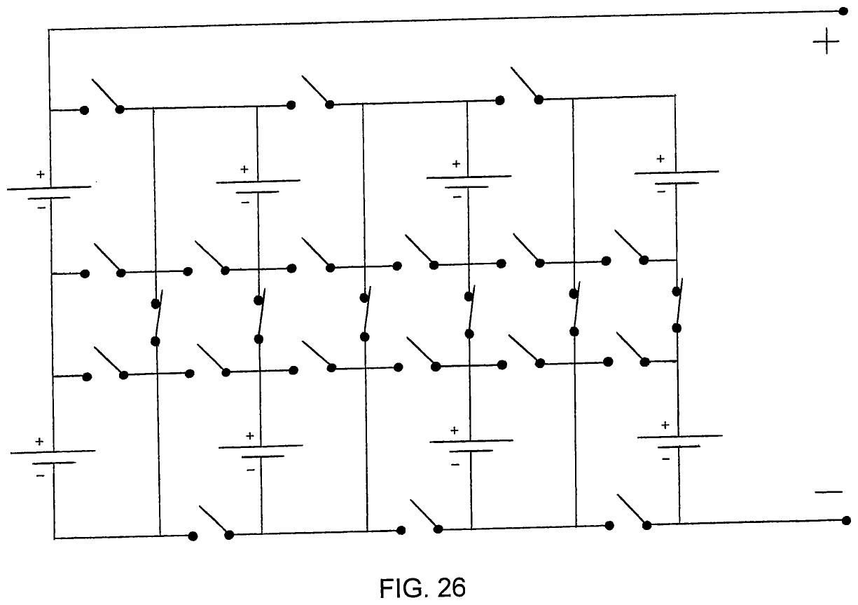

At this point, it should be evident that employing additional electrochemical units, supplemental conductors, and switching devices will increase the number and variety of connection modes. This fact is demonstrated by the embodiment depicted in FIGS. 26 through 33. That embodiment features eight electrochemical units, twenty-three specially arranged supplemental conductors (said supplemental conductors identified as elements 9a through 9w in FIG. 9), and twenty-four strategically interspersed switches. Those components, as structured, enable at least four connection modes.

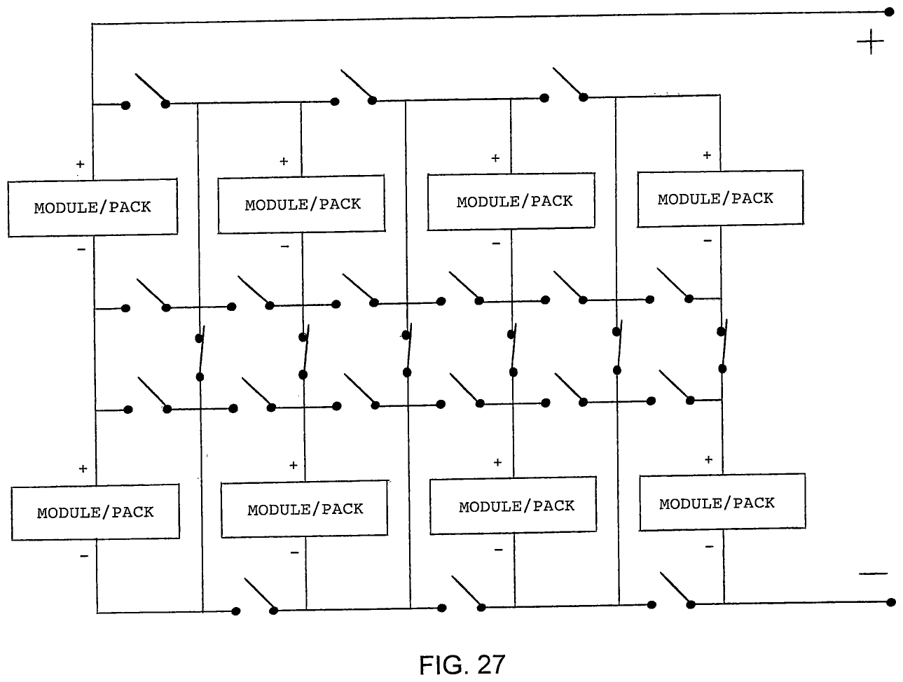

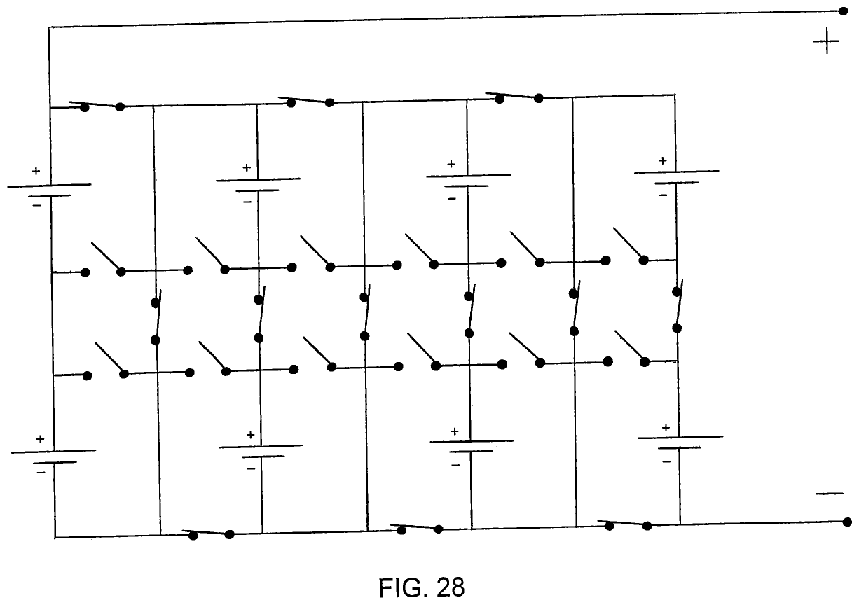

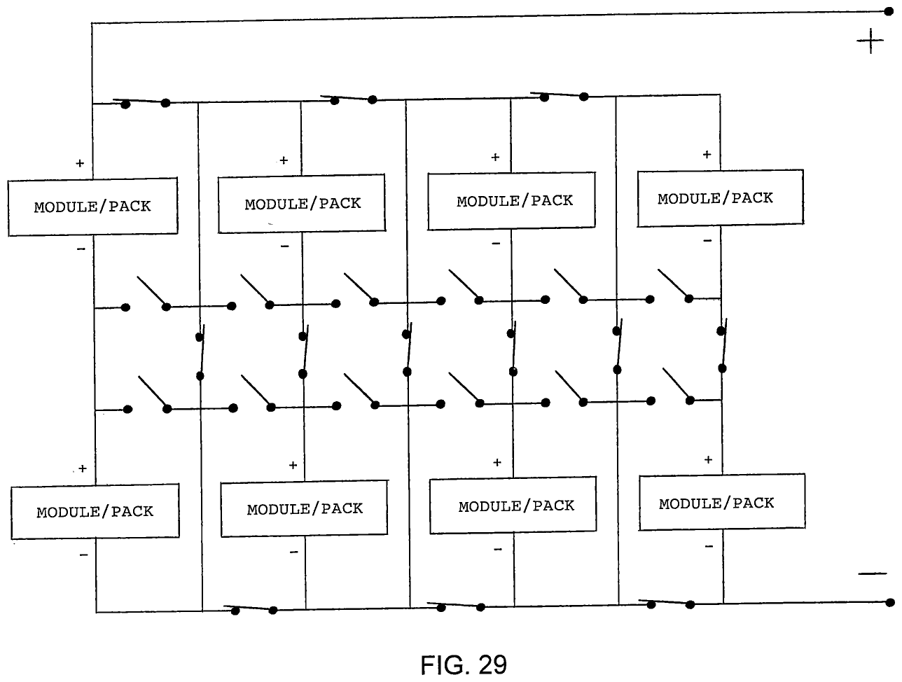

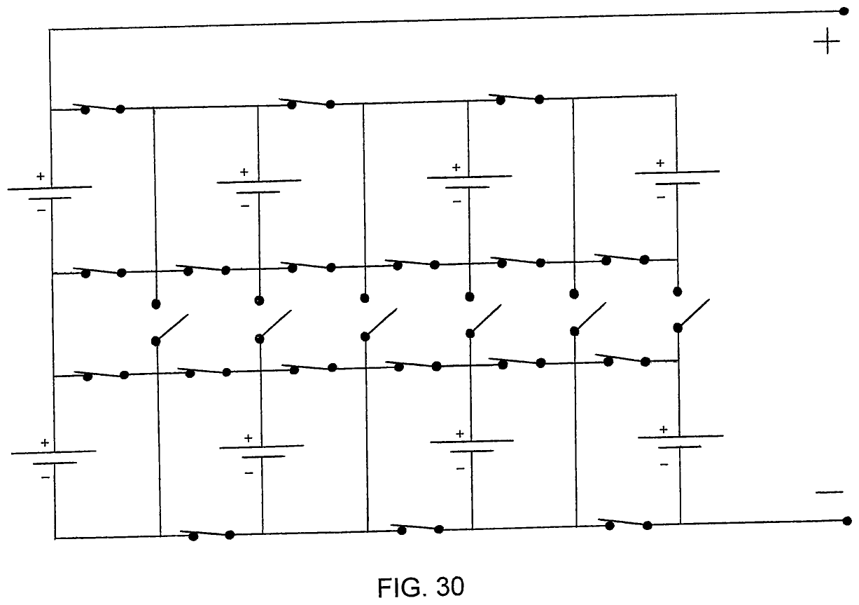

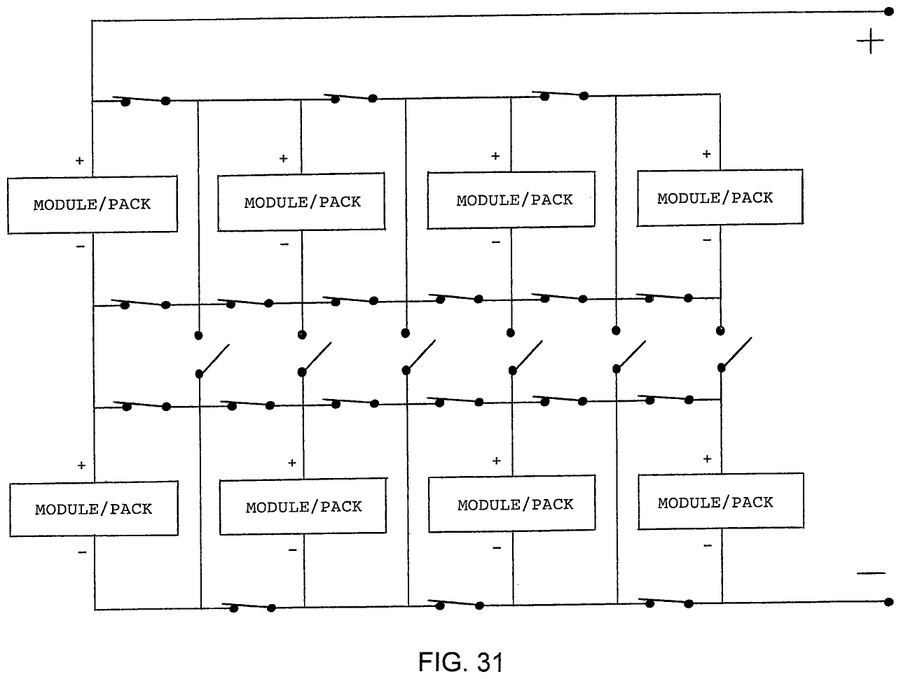

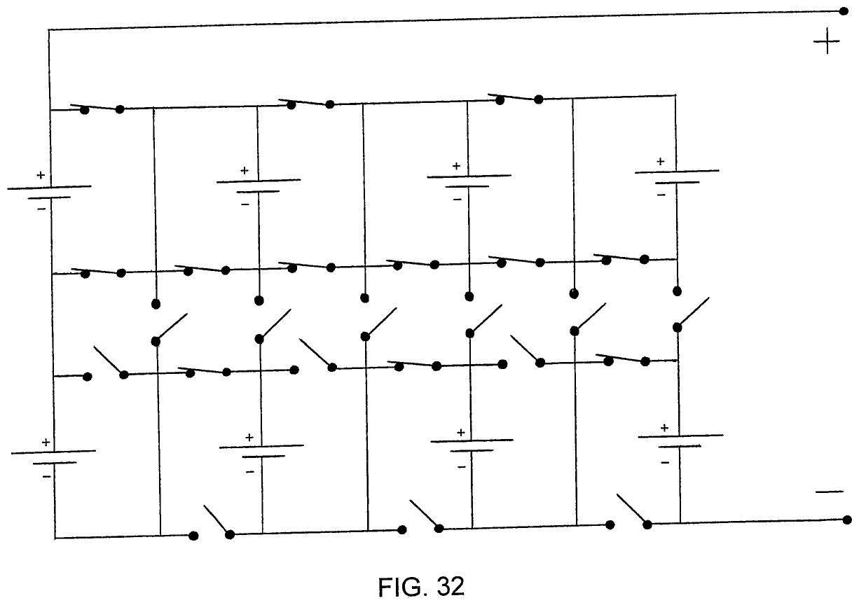

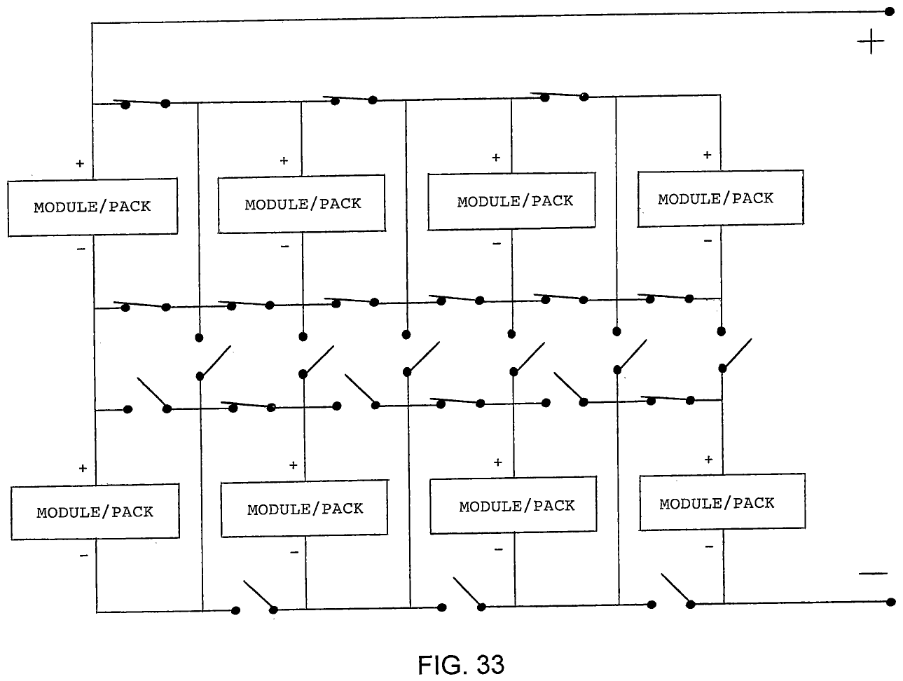

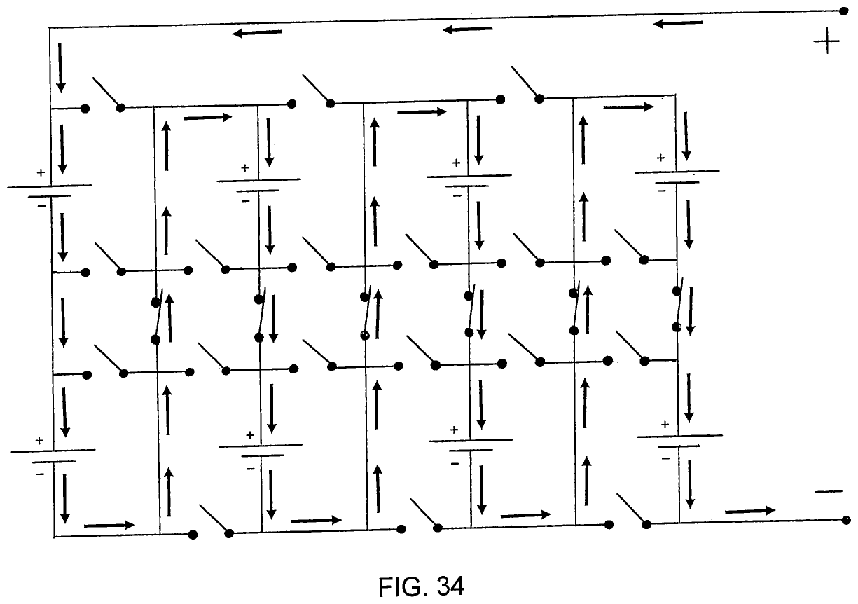

Specifically, referring to the aforementioned drawings, select switches can be closed and opened to configure the electrochemical units to operate in series mode (as shown in FIGS. 26 and 27); in parallel mode (as shown in FIGS. 28 and 29); and in two variations of series-parallel mode (as shown in FIGS. 30 and 31 and FIGS. 32 and 33). Such connection modes are illuminated by FIGS. 34 through 41, which show the path and direction of current flow during charging and discharging.

Of the aforementioned current-flow diagrams, FIGS. 34 and 35 illustrate current flow during charging and discharging for the series configuration depicted in FIGS. 26 and 27. FIGS. 36 and 37 illustrate current flow during charging and discharging for the parallel configuration depicted in FIGS. 28 and 29. FIGS. 38 and 39 illustrate current flow during charging and discharging for the series-parallel configuration depicted in FIGS. 30 and 31. Finally, FIGS. 40 and 41 illustrate current flow during charging and discharging for the series-parallel configuration depicted in FIGS. 32 and 33.

Although the embodiment shown in FIGS. 26 through 33 features twenty-four switches and eight electrochemical units (meaning that the switch-to-unit ratio is 3:1), it should be understood that additional electrochemical units can be incorporated therein. In such an event, the ratio of switches to electrochemical units will drop below 3:1, thereby distinguishing the invention from prior-art systems.

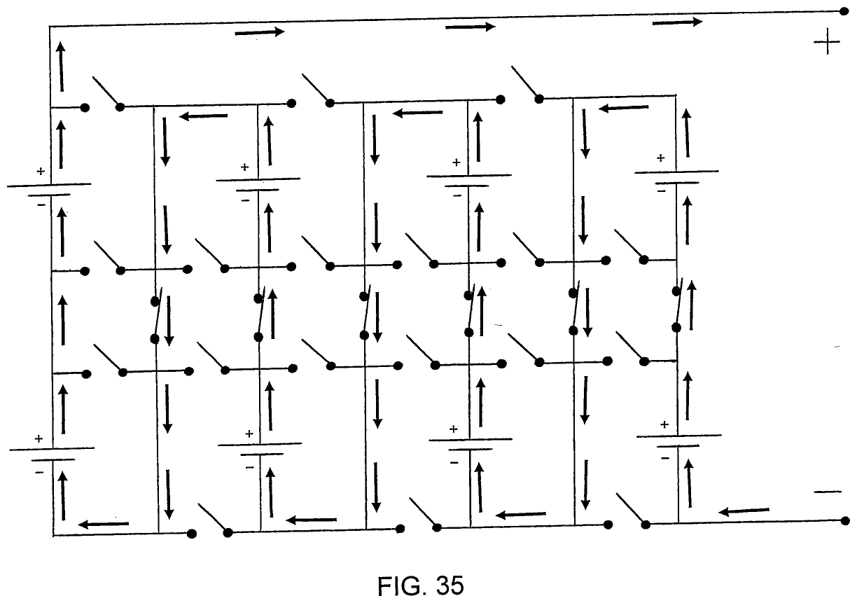

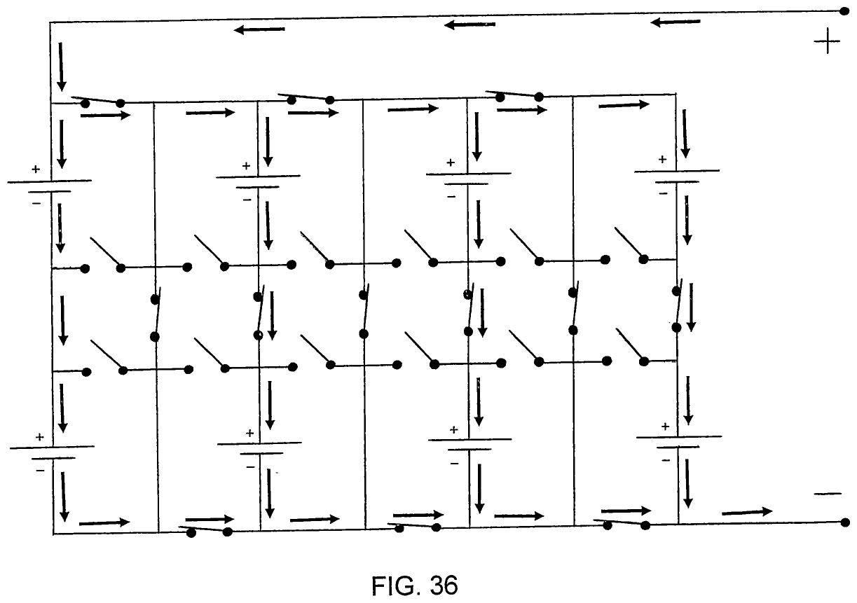

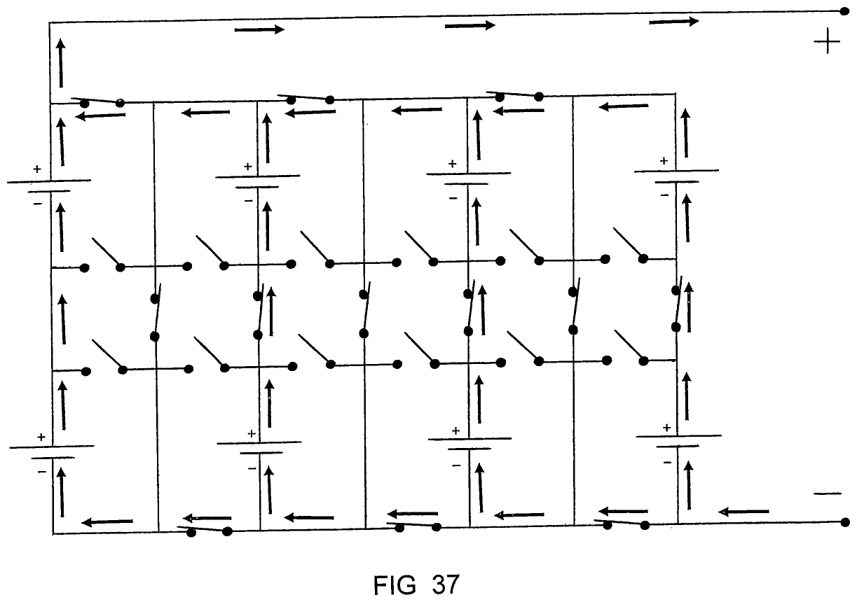

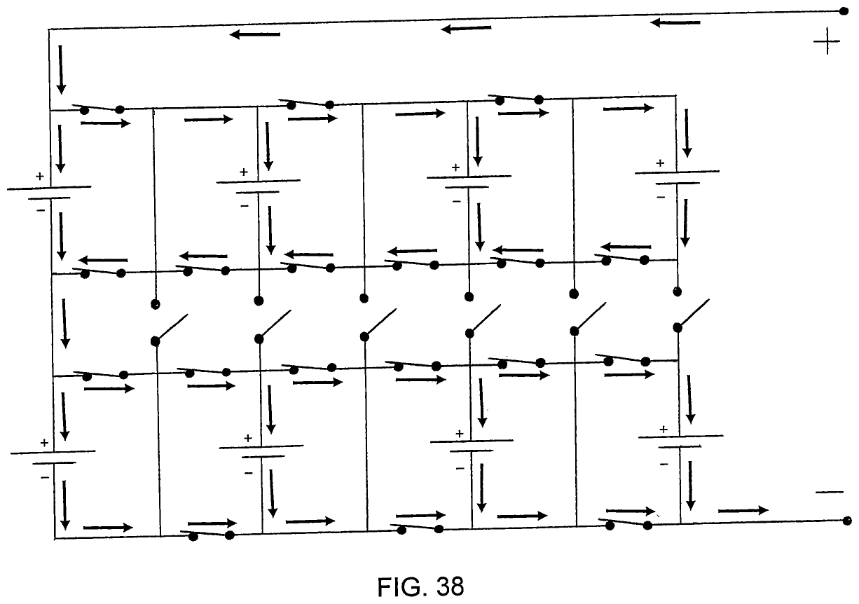

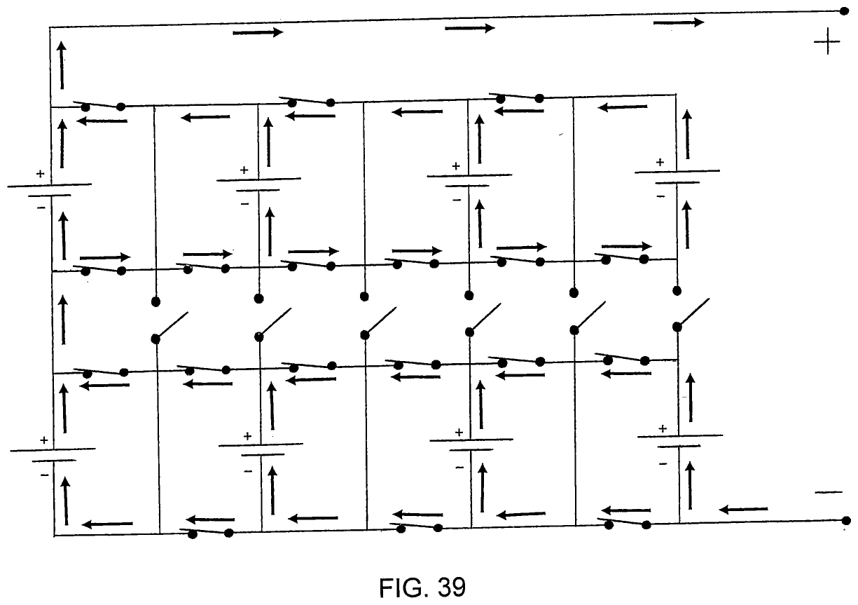

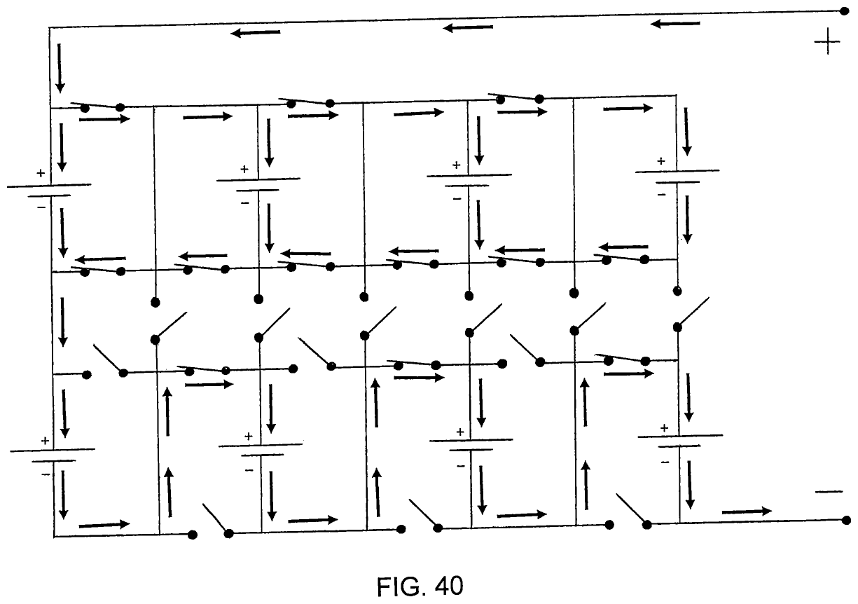

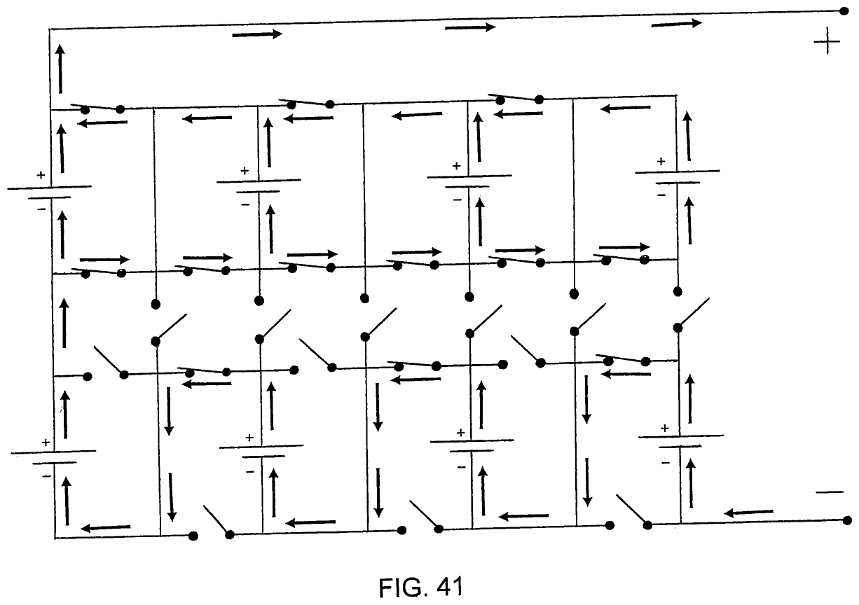

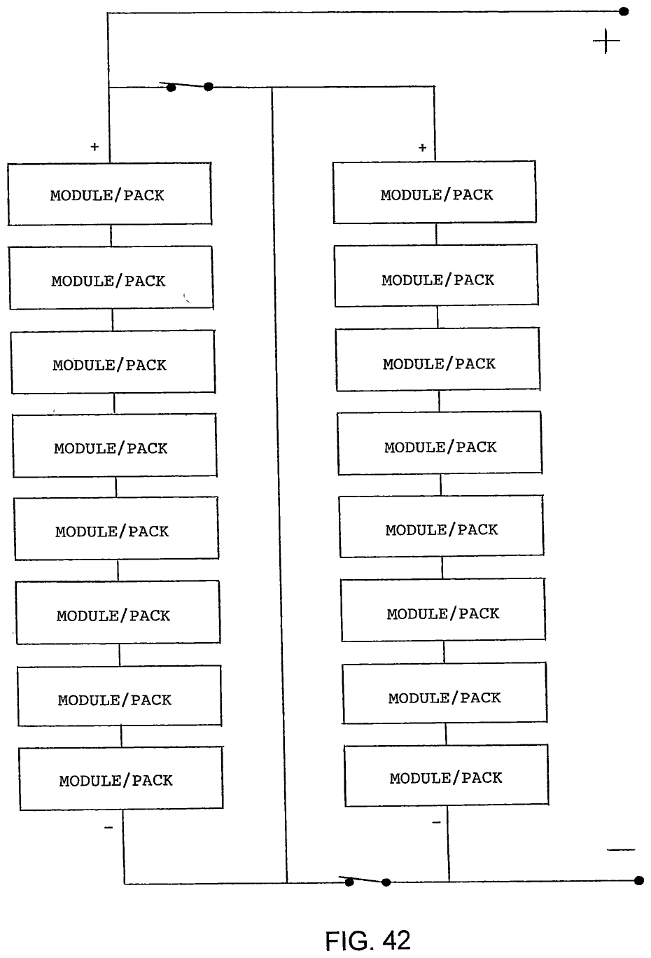

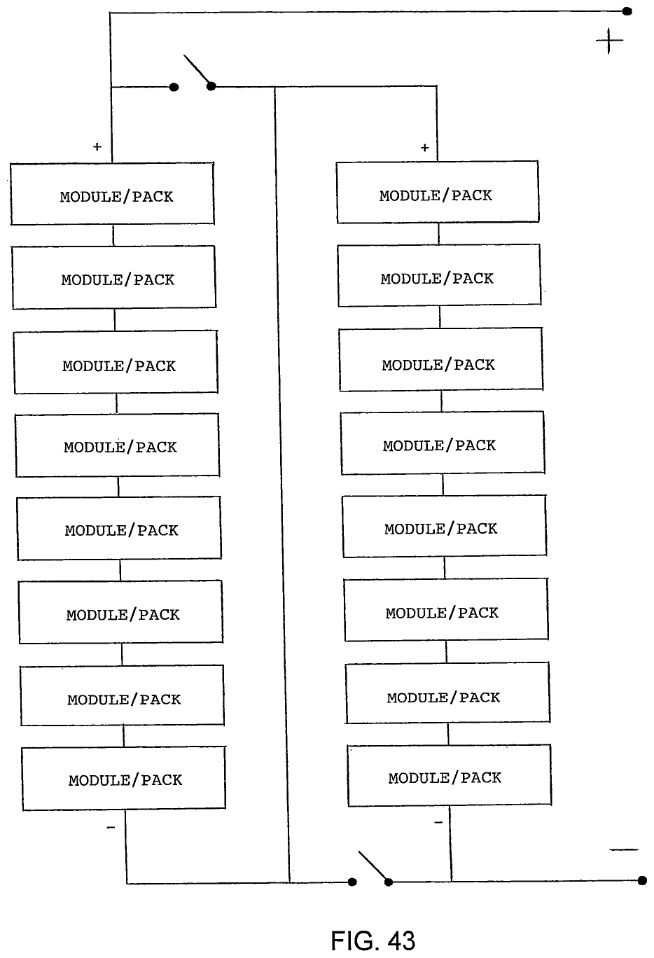

The next series of drawings, namely, FIGS. 42 through 43, depict another embodiment of the circuit-switchable battery system as invented. The embodiment therein features sixteen modules/packs. Those modules/packs are arranged in two eight-unit columns. The columns are separated by one vertically oriented supplemental conductor. Also employed are two switches, which are strategically interspersed along the bottom and intermediate rails of the battery network.

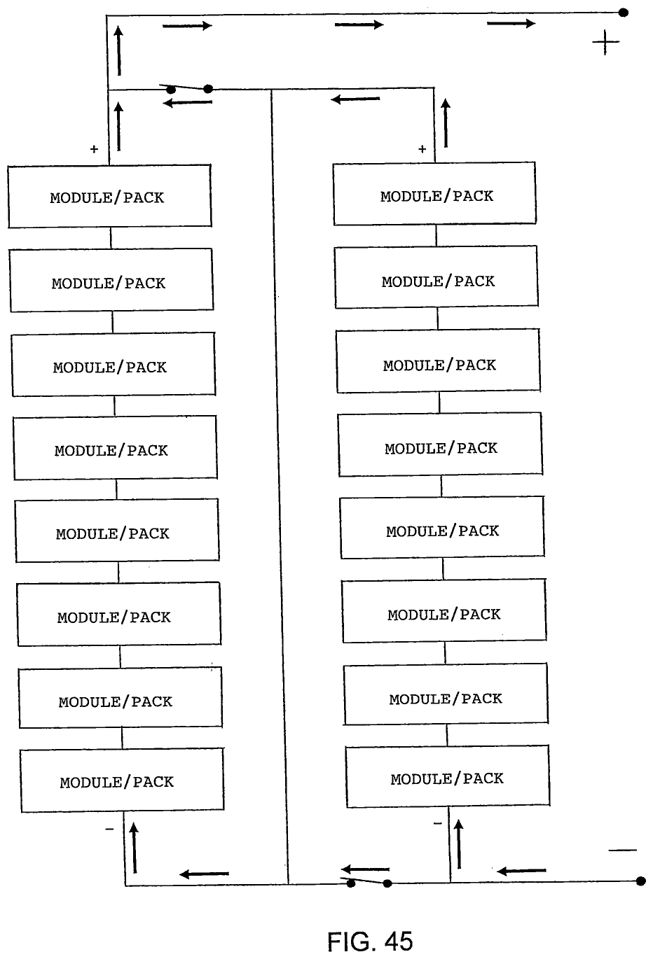

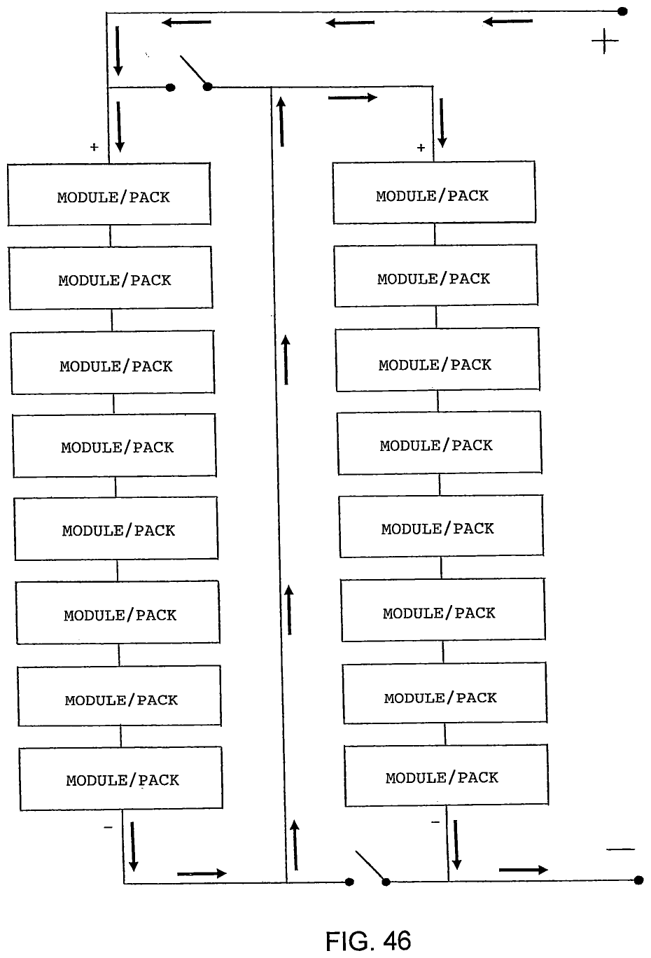

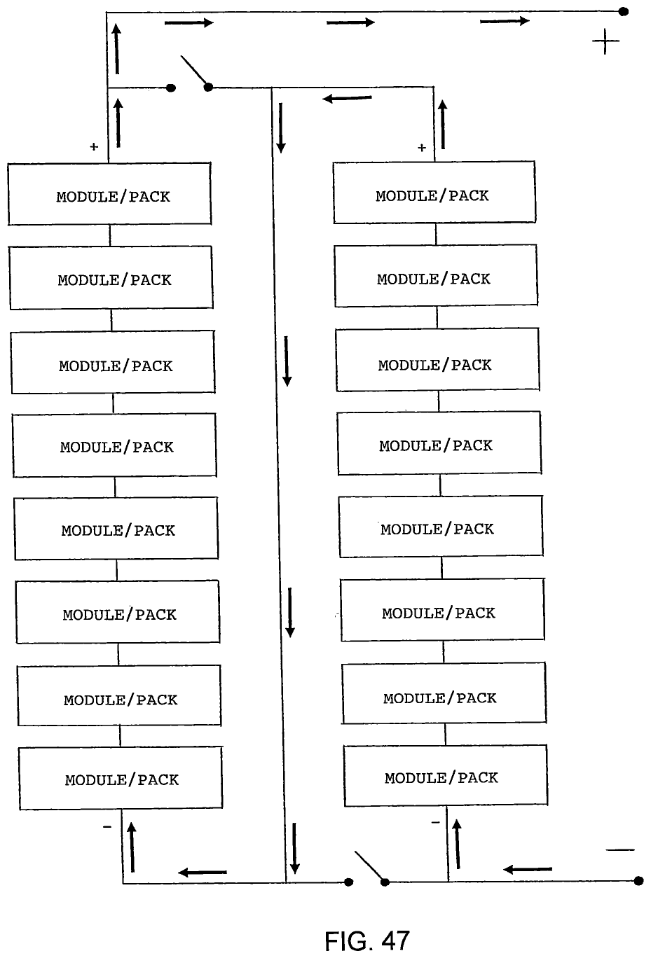

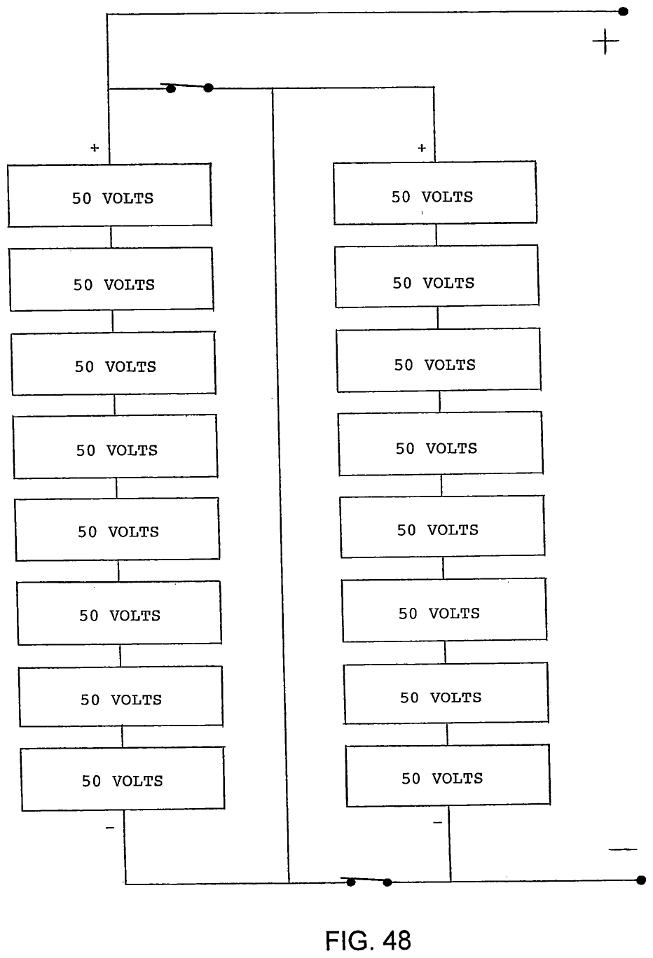

The aforementioned configuration (as well as the configuration illustrated in FIGS. 48, 49, 54, and 55) features switch-to-unit ratios below 3:1. Such configurations are thus structurally distinguishable over prior-art systems.

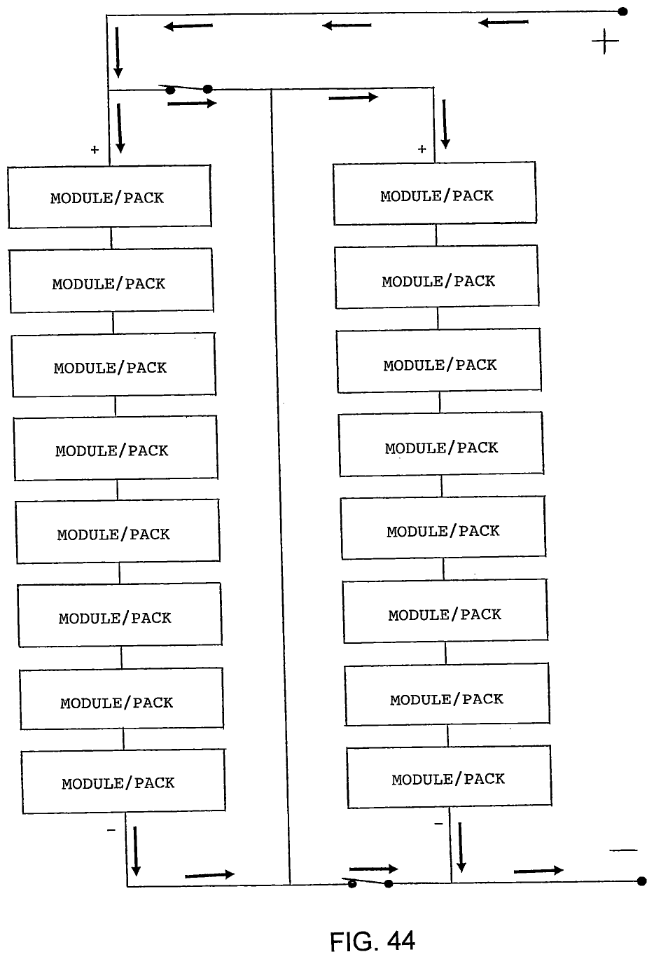

The embodiment depicted in FIGS. 42 and 43 is capable of two connection modes. In particular, as highlighted by the current-flow arrows in FIGS. 44 and 45, series mode can be achieved by closing both switches. Conversely, as highlighted by the current-flow arrows in FIGS. 46 and 47, parallel mode can be achieved by opening both switches.

The sixteen-unit configuration depicted in FIGS. 42 and 43 is especially suited for electric vehicles. By employing that embodiment, or variations thereof, skilled artisans can create battery systems with 400-volt and 800-volt modes (among other voltage ratings). Those voltage modes, of course, will be reconfigurable. Battery systems for electric vehicles can therefore switch between 400-volt connections (in parallel mode) and 800-volt connections (in series mode), thus providing various advantages during charging and/or discharging.

The advantages of dual-voltage battery systems, particularly in relation to electric vehicles, will be discussed shortly. For now, focus will be placed on creating the reconfigurable 400-volt and 800-volt system envisioned.

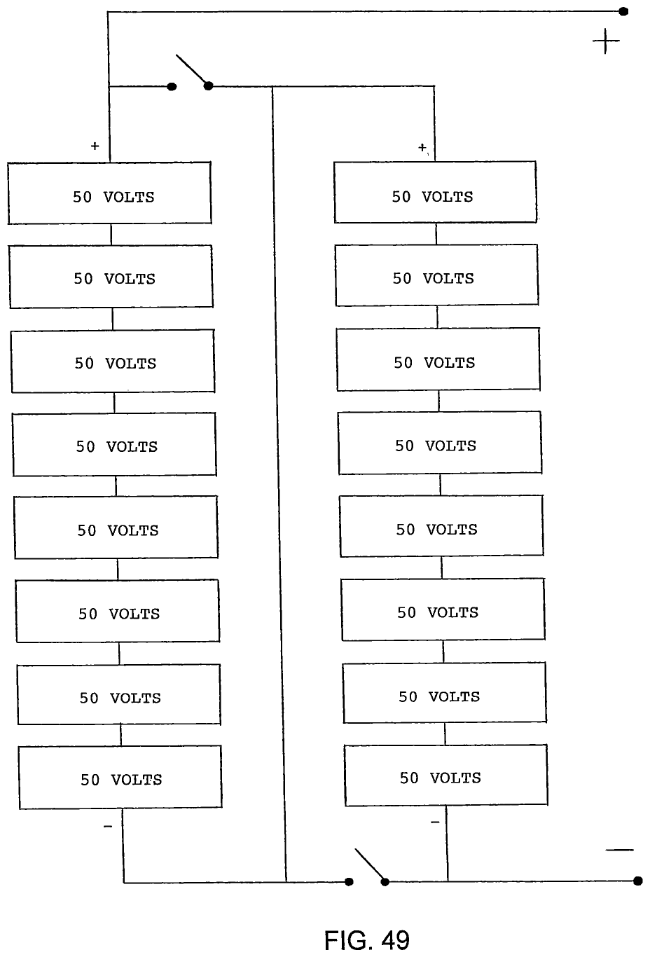

Attention, accordingly, is directed to FIGS. 48 and 49. Shown therein are 50-volt electrochemical units structured pursuant to the prior embodiment. The 50-volt units may comprise modules, packs, or any other container or enclosure capable of forming 50 volts of electrical potential between the battery terminals. The 50-volt metric may be calculated by using the minimum, nominal, or maximum cell rating.

For reference purposes, most lithium-ion cells employing nickel-cobalt-aluminum cathodes feature minimum, nominal, and maximum electrical potentials of around 3.0 volts, 3.6 volts, and 4.2 volts, respectively. A module minimally rated at 51.0 volts could therefore be constructed by using 17 series-connected cells, while modules nominally and maximally rated at 50.4 volts could be constructed by using 14 and 12 series-connected cells, respectively. Of course, such modules may also contain multiple series strings arranged in parallel without impacting the respective voltage ratings.

Thus, by way of example, modules may comprise cells arranged in 17s26p configuration (meaning that each module features 17 cells in series and 26 strings in parallel). That configuration, which encompasses 442 cells per module, is minimally rated at 51.0 volts. Modules may also comprise cells arranged in 14s32p configuration (meaning that each module features 14 cells in series and 32 strings in parallel). That configuration, which encompasses 448 cells per module, is nominally rated at 50.4 volts. Modules may also comprise cells arranged in 12s37p configuration (meaning that each module features 12 cells in series and 37 strings in parallel). That configuration, which encompasses 444 cells per module, is maximally rated at 50.4 volts. These cell arrangements are inclusive, as many other configurations are possible.

Regardless of how the 50-volt rating is achieved, and regardless of whether the voltage rating is measured minimally, nominally, or maximally, the embodiment shown in FIGS. 48 and 49 is capable of operating in dual modes. Those modes, as indicated above, enable battery systems to switch between 400-volt connections and 800-volt connections.

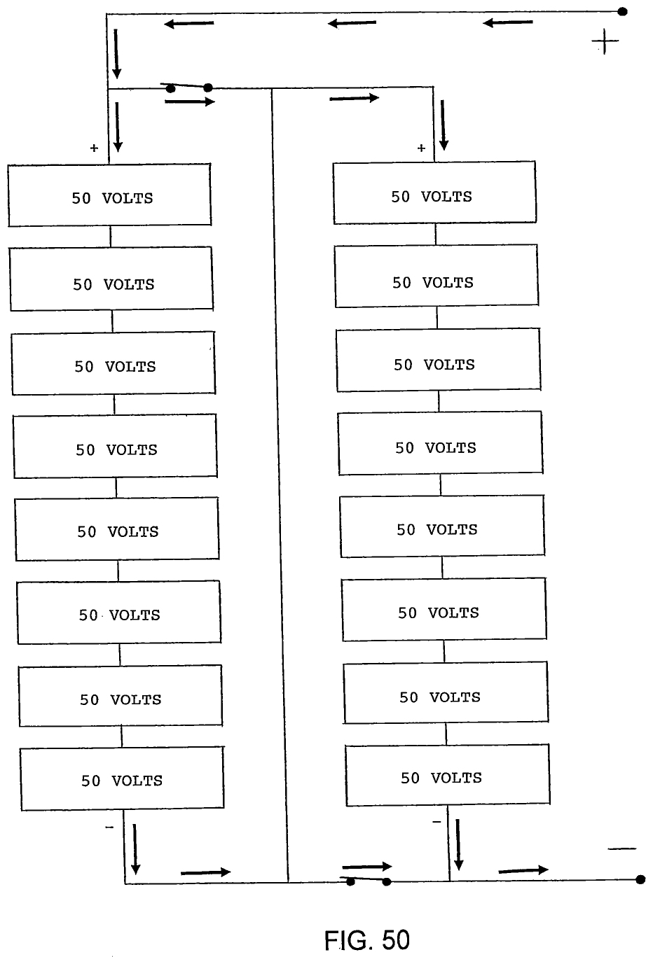

Specifically, closing all switches (as shown in FIG. 48) places each eight-unit column in parallel mode. That connection mode is highlighted by the associated current-flow diagrams, FIGS. 50 and 51, which show the path and direction of current flow during charging and discharging. Because each column totals 400 volts, the total electrical potential from the parallel arrangement will be identical, i.e., 400 volts.

Switching to 800-volt mode is similarly possible and similarly straightforward. In contrast to the 400-volt setting, opening all switches (as shown in FIG. 49) will connect all 50-volt units in series mode. That connection mode is highlighted by the associated current-flow diagrams, FIGS. 52 and 53. Because series mode has an additive effect on overall voltage, the electrical potential will total 800 volts.

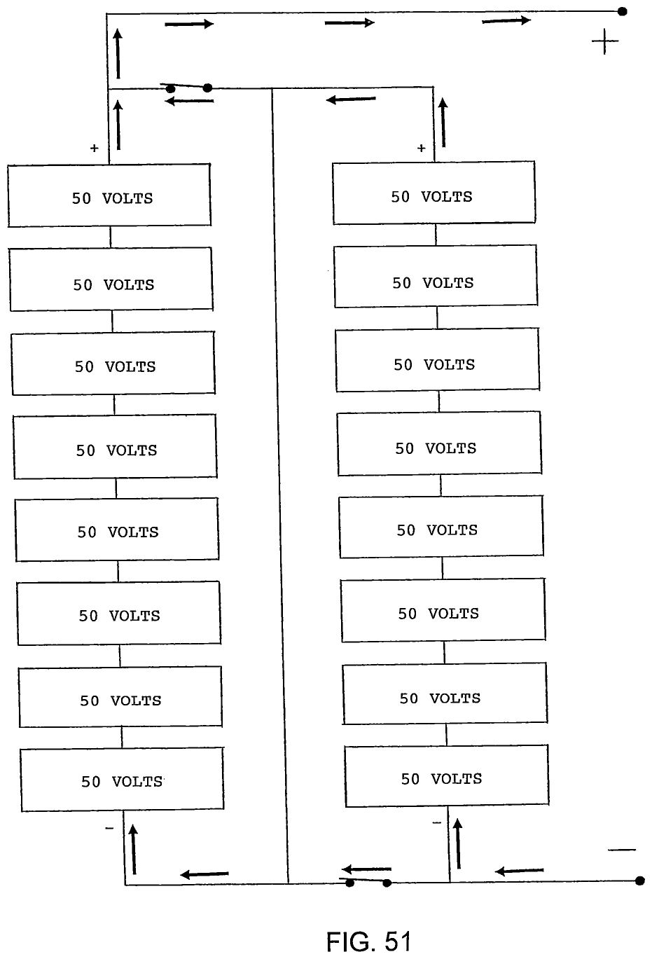

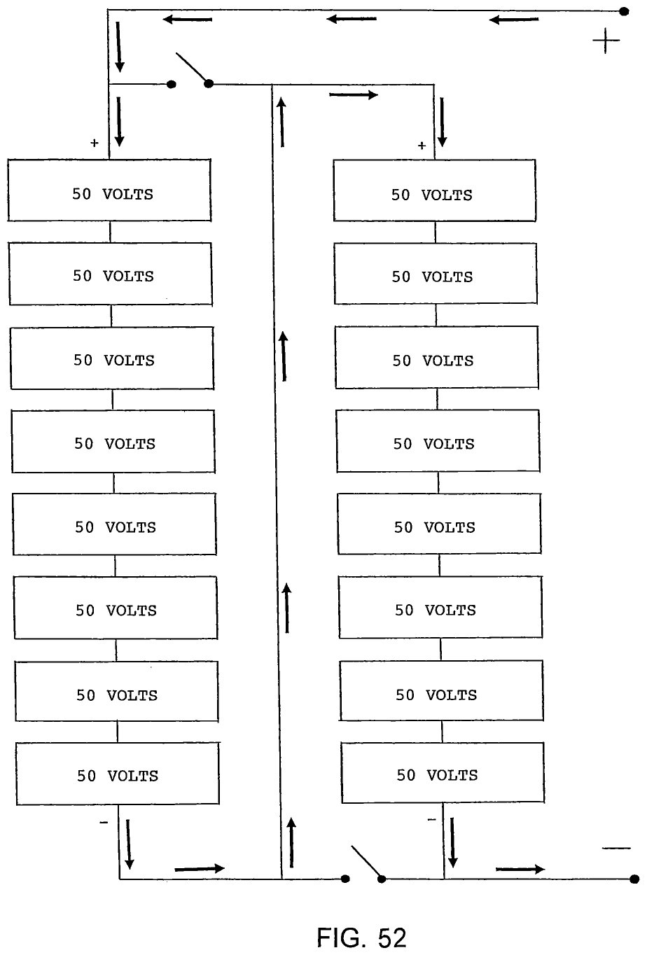

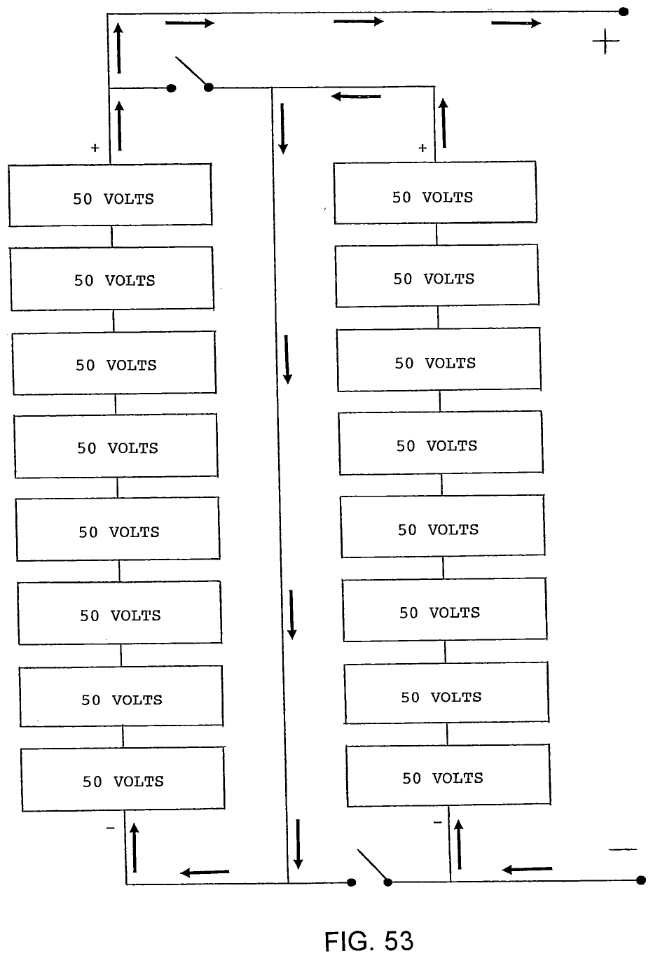

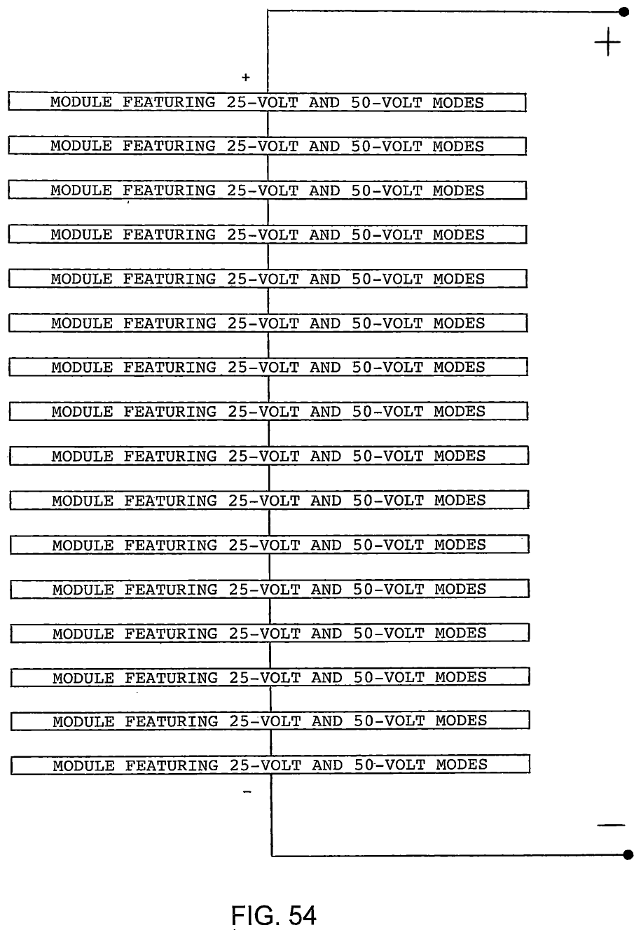

The embodiment depicted in FIGS. 48 and 49 utilizes specially arranged conductors and strategically interspersed current-regulating devices located on the outside of the electrochemical modules. However, constructing battery systems with 400-volt and 800-volt modes (or any other dual-voltage or multi-voltage ratings) can be achieved intra-modularly, that is, by employing internal supplemental conductors and internal regulating devices. Such an embodiment is shown in FIG. 54.

FIG. 54, in particular, features sixteen electrochemical modules. Each module is capable of internally switching between 25-volt and 50-volt connections. Because all sixteen electrochemical modules are arranged in series, switching each module to its 25-volt rating (by internally activating parallel mode) will create 400 volts of electrical potential, while switching each module to its 50-volt rating (by internally activating series mode) will create 800 volts of electrical potential. Such intra-modular mode changes are accomplished through specially arranged conductors and strategically interspersed current-regulating devices located within the individual electrochemical modules.

At this point, it must be emphasized that the embodiment depicted in FIG. 54 features not only 400-volt and 800-volt modes but also intermediate-voltage modes. This is because each of the sixteen electrochemical modules can be individually switched from 25 volts to 50 volts (and vice versa). The disclosed system, as such, can operate at 25-volt increments (namely, 400 volts, 425 volts, 450 volts, etc.). The embodiment shown in FIG. 54 is therefore more configurable, as well as more capable, than the prior embodiment.

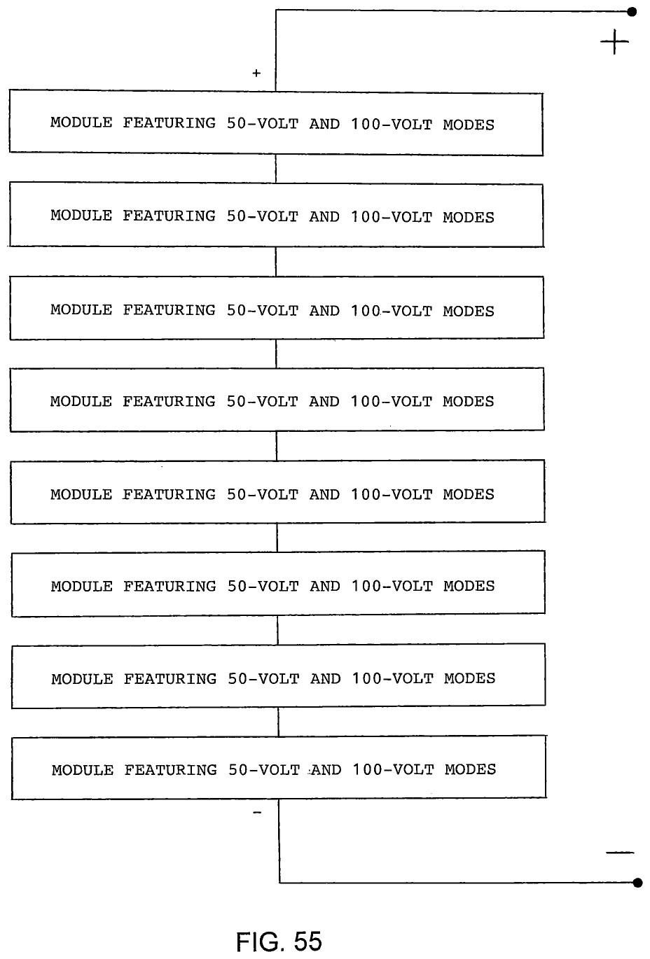

As with all prior embodiments, any number of electrochemical units can be employed, with such electrochemical units having whatever voltage rating desired. FIG. 55, in that spirit, employs eight electrochemical modules rather than sixteen. Each module is capable of operating at 50 volts or 100 volts, giving the battery system 400 volts of electrical potential (by intra-modularly activating parallel mode) or 800 volts of electrical potential (by intra-modularly activating series mode). And just like the prior embodiment, the embodiment shown in FIG. 55 is capable of switching to various intermediate-voltage modes, albeit at 50-volt increments.

Because the embodiments depicted in FIGS. 54 and 55 employ intra-modular switches, such switches are not visible in those drawings. It is nevertheless envisioned that the ratio of switches to electrochemical units be under 3:1. In that respect, among others, the embodiments shown in FIGS. 54 and 55 are structurally distinguishable over prior-art systems.

Regardless of which embodiment is employed, the invention, as disclosed, allows battery systems to selectively and temporarily switch between 400-volt connections (in parallel mode) and 800-volt connections (in series mode). This switching capability, whether involving 400 volts, 800 volts, or other voltage levels, provides numerous advantages during the charging and discharging processes. Such advantages are especially appealing with regard to electric-vehicle applications.

It is known that lower-voltage battery systems (e.g., 400-volt packs) enable longer battery life compared to higher-voltage battery systems. The reason stems from the number of series-connected cells in relation to the number of parallel-connected cells. Battery packs for electric vehicles typically contain thousands of cells. Cells connected in series, to reiterate, have an additive effect on voltage. A nominally rated 350-volt pack (which translates to 400 volts maximum) will therefore feature 96 series-connected cells (assuming that each cell is nominally rated at 3.6 volts). All remaining cells will be connected in parallel, with those parallel-connected cells increasing energy capacity, measured in ampere-hours. So lower-voltage systems enable longer battery life given the greater number of parallel-connected cells.

In relation to lower-voltage battery systems, however, higher-voltage systems (e.g., 800-volt packs) enable safer and/or faster charging. Once again, cell arrangement comes into play. This is because an increase in voltage requires an increase in the number of series-connected cells, meaning that fewer parallel-connected cells are employed in the battery system. Significantly, using fewer parallel-connected cells lowers intra-network current flow and associated heat production. The reduced current/heat, in turn, will preserve electrochemical integrity, resulting in safer charging. Of course, any reduction in current/heat can be offset by increasing charging current, thus lowering recharging time.

As can be seen, lower-voltage battery systems (e.g., 400-volt packs) have the advantage of enabling longer battery life. That advantage is attributed to the relatively greater number of parallel-connected cells employed in the network. Higher-voltage battery systems (e.g., 800-volt packs), on the other hand, have the advantage of enabling safer and/or faster charging. That advantage is attributed to the relatively lower number of parallel-connected cells employed in the network. Both advantages can be realized by practicing the circuit-switchable battery system in the above manner.

It is worth noting that the circuit-switchable feature of the invention can be practiced differently, in which event different advantages may accrue. One potential advantage allows battery systems to compensate for discharge-related voltage drops. In other words, the invention, if practiced in the manner indicated below, is capable of flattening the normally downward voltage-indexed discharge curve.

It is known that electrochemical units (such as cells, modules, and packs) experience progressive voltage drops when undergoing depletion. A fully charged battery pack maximally rated at 400 volts, for example, could have its electrical potential reduced by 20% to 35%, to around 290 volts, once its low-energy state is reached. The percentage of the voltage drop, as well as the steadiness thereof, will vary among battery categories, such as nickel-cadmium, nickel-metal hydride, and lithium-ion. All electrochemical units, however, experience voltage drops during the discharge phase.

The disclosed battery system can be employed to offset such discharge-related voltage drops. Specifically, during the discharge process, battery systems can increase the number of series-connected electrochemical cells, modules, or packs by reconfiguring their electrical connections. That connection-mode change will result in an increase in systemic voltage, thus offsetting discharge-related voltage drops.

To illustrate the foregoing concept, attention is directed to FIGS. 54 and 55. The embodiments therein, as indicated, feature intermediate-voltage modes. It will be assumed, for illustrative purposes, that all modules in FIGS. 54 and 55 are internally switched to parallel mode, giving the battery system 400 volts of electrical potential. The 400-volt rating, of course, will progressively decline during the discharge process. When the declining electrical potential reaches, say, 375 or 350 volts, then one of the modules in FIGS. 54 and 55 can increase its output by 25 or 50 volts, respectively. Such an increase in output (which is accomplished intra-modularly) will cause systemic electrical potential to return to 400 volts, thus compensating for the discharge-related voltage drop. Additional modules can thereafter be up-rated during the discharge phase if necessary or desired.

By practicing the invention in the foregoing manner, it will be possible to eliminate or mitigate voltage drops while discharging. Significant advantages can be realized therefrom. Battery systems, for one thing, will be able to maintain consistent and reliable output throughout the discharge phase, thus overcoming major prior-art limitations.

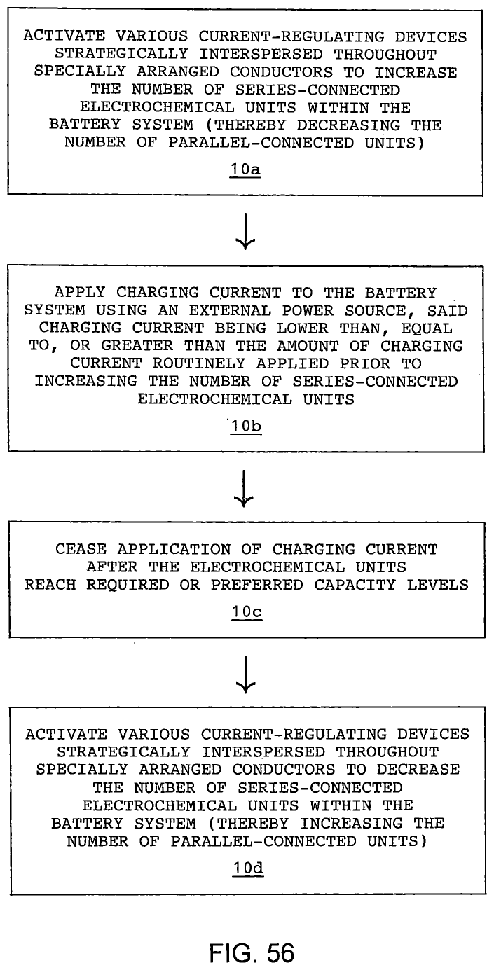

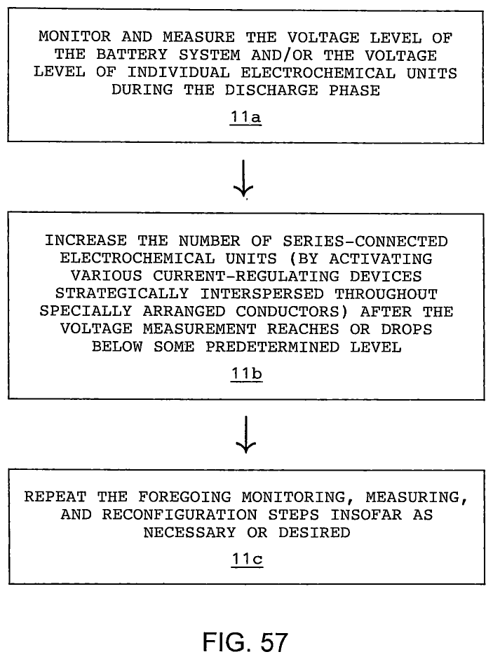

The invention, it goes without saying, possesses substantial versatility and utility. Given the foregoing considerations, practitioners may choose to implement one or more embodiments of the invention in accordance with the methodology outlined in FIGS. 56 and 57. Those drawings, all of which are in flowchart format, outline various operational processes capable of being employed when charging and/or discharging electrochemical cells, modules, or packs.

As indicated by FIG. 56, the methodology therein encompasses four basic steps. The first step involves increasing the number of series-connected electrochemical units within the battery system (and thereby correspondingly decreasing the number of parallel-connected units) by activating various current-regulating devices strategically interspersed throughout the special network of conductors (process 10a). The second step involves applying charging current to the battery system, said charging current being lower than, equal to, or greater than the amount of charging current routinely applied prior to increasing the number of series-connected electrochemical units (process 10b). The third step involves ceasing charging current after the electrochemical units reach required or preferred capacity levels (process 10c). The fourth step involves decreasing the number of series-connected electrochemical units within the battery system (and thereby correspondingly increasing the number of parallel-connected units) by activating various current-regulating devices strategically interspersed throughout the special network of conductors (process 10d). These steps are inclusive and exemplary, as different or additional processes can be adopted and performed within the scope of the invention.

Case in point, FIG. 57 illustrates an alternative method capable of being practiced. The methodology therein encompasses three basic steps. The first step involves monitoring and measuring the voltage level of the battery system and/or the voltage level of individual electrochemical units during the discharge phase (process 11a). The second step involves increasing the number of series-connected electrochemical units (by activating various current-regulating devices strategically interspersed throughout the special network of conductors) after the voltage measurement reaches or drops below some predetermined level (process 11b). The third step involves repeating the foregoing monitoring; measuring, and reconfiguration processes insofar as necessary or desired (process 11c). These steps, too, are inclusive and exemplary, for different or additional processes can certainly be implemented in accordance with the invention.

Based on the present disclosure, it should become clear that the circuit-switchable battery system at issue features numerous permutations. Those permutations do not limit the invention but, instead, demonstrate the flexibility of the disclosed battery system. For that reason, artisans and manufacturers can alter, substitute, combine, or supplement various aspects of the disclosed battery system without departing from the scope of the invention, which is defined by the below claims rather than by the specific embodiments, advantages, or other aspects discussed herein.

What is claimed is:

1. A battery system, said system comprising: multiple electrochemical units for receiving, storing, and providing electricity; and mode-transitioning means for enabling said system to selectively and temporarily reconfigure its electrical connections and thereby switch from, to, among, or between series mode, parallel mode, or series-parallel mode for charging or discharging purposes, said mode-transitioning means encompassing at least two current-regulating devices, wherein the ratio of said current-regulating devices to said electrochemical units is under 3:1, respectively.

2. A battery system, said system comprising: multiple electrochemical units for receiving, storing, and providing electricity; an integrated network of conductors for carrying and transmitting electricity, wherein said conductors are in communication with the electrochemical units via two or more connection modes, said connection modes being selected from the group consisting of series, parallel, and series-parallel connections; and current-regulating devices for controlling the path of electricity through the network of conductors and thereby controlling whether the electrochemical units are connected in series mode, parallel mode, or series-parallel mode, wherein the ratio of said current-regulating devices to said electrochemical units is under 3:1, respectively; and wherein changes in connection mode will have an impact on the systemic electrical characteristics of the battery system.

3. The system of claim 2, wherein said network of conductors comprises one or more metallic wires.

4. The system of claim 2, wherein said network of conductors comprises one or more metallic rails.

5. The system of claim 2, wherein said network of conductors comprises one or more metallic circuit-board traces.

6. The system of claim 2, wherein said network of conductors comprises an air-based induction medium.

7. The system of claim 2, wherein said electrochemical units comprise one or more single-cell containers.

8. The system of claim 2, wherein said electrochemical units comprise one or more multi-cell containers.

9. The system of claim 2, wherein said electrochemical units comprise one or more multi-cell modules.

10. The system of claim 2, wherein said electrochemical units comprise one or more multi-cell packs.

11. The system of claim 2, wherein said current-regulating devices comprise one or more mechanical switches.

12. The system of claim 2, wherein said current-regulating devices comprise one or more transistors.

13. The system of claim 2, wherein said current-regulating devices comprise one or more rectifiers.

14. The system of claim 2, wherein said current-regulating devices comprise one or more relays.

15. The system of claim 2, wherein said current-regulating devices comprise one or more parts of an auxiliary, master, or supervisory battery-management system or appliance.

16. The system of claim 2, wherein said system is utilized to implement, or is subjected to, the following operational processes: increasing the number of series-connected units by selectively routing electricity through the network of conductors and thereby altering the systemic electrical characteristics of the electrochemical units; applying charging current to the electrochemical units using an external power source; ceasing the application of charging current after the electrochemical units reach required or preferred capacity levels; and decreasing the number of series-connected units by selectively routing electricity through the network of conductors and thereby altering the systemic electrical characteristics of the electrochemical units.

17. The system of claim 16, wherein said charging current is less than the amount of charging current routinely applied prior to increasing the number of series-connected units.

18. The system of claim 16, wherein said charging current is equal to the amount of charging current routinely applied prior to increasing the number of series-connected units.

19. The system of claim 16, wherein said charging current is greater than the amount of charging current routinely applied prior to increasing the number of series-connected units.

20. The system of claim 2, wherein said system is utilized to implement, or is subjected to, the following operational processes: monitoring and measuring the voltage level of one or more electrochemical units, said monitoring and measuring occurring at some point during the discharge phase; increasing the number of series-connected electrochemical units by selectively routing electricity through the network of conductors and thereby altering the systemic electrical characteristics of the electrochemical units, wherein said increase in series-connected units occurs after the voltage measurement reaches or drops below some predetermined level; and repeating the foregoing steps if necessary or desired.
